(19) United States
(12) Patent Application Publication
(10) Pub. No.: US 2025/0317810 A1
(43) Pub. Date: Oct. 9, 2025

(54) COMMUNICATION METHOD AND APPARATUS

(71) Applicant: HUAWEI TECHNOLOGIES CO., LTD., Shenzhen (CN)

(72) Inventors: Yuanping Zhu, Shanghai (CN); Yibin Zhuo, Shenzhen (CN); Jing Liu, Shenzhen (CN); Mingzeng Dai, Shenzhen (CN)

(73) Assignee: HUAWEI TECHNOLOGIES CO., LTD., Shenzhen (CN)

(21) Appl. No.: 19/244,773

(22) Filed: Jun. 20, 2025

Related U.S. Application Data
(63) Continuation of application No. 17/871,364, filed on Jul. 22, 2022, now Pat. No. 12,369,080.
Application No. 17/871,364 is a continuation of application No. PCT/CN2020/074032, filed on Jan. 23, 2020.

(51) Int. Cl. H04W 36/00; H04W 36/08; H04W 88/08; H04W 92/24

(52) U.S. Cl. CPC H04W 36/0061; H04W 36/087; H04W 88/08; H04W 92/24

(57) ABSTRACT

A communication method and apparatus are provided. The method includes: A first IAB node receives a first message from a CU of an IAB donor, where the first message indicates the first IAB node to be handed over from a first parent node to a second parent node, and the first message includes a first IP address of the first IAB node. The first IAB node determines first transport network layer association information between the first IAB node and the CU of the IAB donor based on the first IP address. The first IAB node updates control plane context information of an F1 interface by using the first transport network layer association information, where the F1 interface is an interface between the first IAB node and the CU of the IAB donor. According to the method and the apparatus in this application, an IAB node may communicate with a CU of an IAB donor by using a first IP address as soon as possible after handover is completed, thereby reducing impact on a service latency of a terminal device served by the IAB node.

### CROSS-REFERENCE TO RELATED APPLICATIONS

This application is a continuation of U.S. patent application Ser. No. 17/871,364, filed on Jul. 22, 2022, which is a continuation of International Application No. PCT/CN2020/074032, filed on Jan. 23, 2020. All of the aforementioned patent applications are hereby incorporated by reference in their entireties.

### TECHNICAL FIELD

This application relates to the field of communication technologies, and in particular, to a communication method and apparatus.

### BACKGROUND

An integrated access and backhaul (integrated access and backhaul, IAB) network technology is introduced into a 5th generation (5th generation, 5G) mobile communication system. A wireless transmission solution is used for both an access link (access link) and a backhaul link (backhaul link) in an IAB network, to avoid optical fiber deployment, thereby reducing deployment costs and improving deployment flexibility. In the IAB network, an IAB donor gNodeB (IAB donor gNodeB, IAB DgNB) is connected to a core network (for example, a core network (5G core, 5GC) in a 5G system) through a wired link, and then an integrated access and backhaul node (integrated access and backhaul node, IAB node) is added between the IAB donor gNodeB and a terminal. A radio access service is provided for the terminal through an access link (access link, AL) of the IAB node, and the IAB node is connected to the IAB donor gNodeB through a backhaul link (backhaul link, BL) of the IAB node, to transmit service data of the terminal.

Currently, when topology update occurs on an IAB network, if an IAB donor gNodeB connected to an IAB node changes, an F1 interface is to be reestablished. Because the F1 interface is to be reestablished, a control plane/user plane context of the F1 interface needs to be regenerated. This greatly affects a service latency of a terminal and causes enormous signaling overheads.

### SUMMARY

This application provides a communication method and apparatus, to resolve a problem that F1 interface reestablishment causes a great service latency and enormous signaling overheads.

According to a first aspect, this application provides a communication method. The method is applicable to a scenario in which a first IAB node is handed over, in a service range of a CU of a same IAB donor, from a first DU of the IAB donor to a second DU of the IAB donor. The method includes: A first IAB node receives a first message from a CU of an IAB donor, where the first message indicates the first IAB node to be handed over from a first parent node to a second parent node. The first parent node is a first DU of the IAB donor, or the first parent node is connected to the CU of the IAB donor through a first DU of the IAB donor. The second parent node is a second DU of the IAB donor, or the second parent node is connected to the CU of the IAB donor through a second DU of the IAB donor. The first message includes a first IP address allocated to the first IAB node. The first IAB node determines, based on the first IP address, first transport network layer association information between the first IAB node and the CU of the IAB donor after the first IAB node is handed over to the second parent node. The first IAB node updates control plane context information of a first interface based on the first transport network layer association information, where the first interface may be an F1 interface between the first IAB node and the CU of the IAB donor.

In this embodiment of this application, when a parent node of the first IAB node is changed due to IAB topology update, the first IAB node obtains the first IP address, and updates the control plane context between the IAB node and the IAB donor based on the first IP address, to avoid a service latency and signaling overheads caused by F1 interface reestablishment. After the handover is completed, the IAB node performs F1 interface communication with the CU of the IAB donor by using the first IP address. In this way, the IAB node may communicate with the CU of the IAB donor by using the first IP address as soon as possible after the handover is completed, thereby reducing impact on a service latency of a terminal device served by the IAB node.

In a possible design, the first IAB node receives, through the first parent node, indication information from the CU of the IAB donor. Alternatively, the indication information is included in the first message. The first IAB node determines, based on the indication information, the first transport network layer association information after the first IAB node is handed over to the second DU of the IAB donor.

In this way, the IAB node updates an F1 interface TNL association as soon as possible after the handover is completed, to restore, as soon as possible, a capability of providing a service for the terminal device, and reduce the impact on the service latency of the terminal device.

In a possible design, the first IAB node generates the first transport network layer association information by using the first IP address.

Alternatively, the first IAB node obtains the first transport network layer association information by adding the first IP address to second transport network layer association information, where the second transport network layer association information is transport network layer association information between the first IAB node and the CU of the IAB donor before the first IAB node is handed over to the second parent node. In a possible design, the first message further includes an IP address of the CU of the

IAB donor, and the IP address of the CU of the IAB donor is used by the IAB node to perform control plane communication with the CU of the IAB donor, and/or the IP address of the CU of the IAB donor is used by the IAB node to determine the first transport network layer association information between the first IAB node and the CU of the IAB donor.

In this way, the IAB node can communicate with the CU of the IAB donor by using the IP address as soon as possible after the handover is completed, thereby reducing the impact, caused by the handover of the IAB node, on the service latency of the terminal device served by the IAB node.

According to a second aspect, an embodiment of this application provides a communication method. The method is applicable to a scenario in which a first IAB node is handed over from a DU of a first IAB donor to a DU of a second IAB donor, that is, the first IAB node is connected to different IAB donors before and after the handover. The method includes: A first IAB node receives a first message from a CU of a first IAB donor, where the first message indicates the first IAB node to be handed over from a first parent node to a second parent node. The first parent node is a DU of the first IAB donor, or the second parent node is connected to the CU of the first IAB donor through a DU of the first IAB donor. The second parent node is a DU of a second IAB donor, or the second parent node is connected to a CU of a second IAB donor through a DU of the second IAB donor. The first message includes an IP address of the first IAB node. After the first IAB node is handed over to the second parent node, the first IAB node determines, based on the first IP address, first transport network layer association information between the first IAB node and the CU of the second IAB donor after the first IAB node is handed over to the second parent node. The first IAB node updates control plane context information of a first interface by using the first transport network layer association information, where the first interface may be an F1 interface between the first IAB node and the second IAB donor. In this embodiment of this application, when a parent node of the first IAB node is

changed due to IAB topology update, the first IAB node obtains the first IP address, and updates the control plane context between the IAB node and the IAB donor based on the first IP address, to avoid a service latency and signaling overheads caused by F1 interface reestablishment.

In a possible design, the first IAB node receives, through the first parent node, indication information from the CU of the first IAB donor. Alternatively, the indication information is included in the first message. The first IAB node determines, based on the indication information, the first transport network layer association information after the first IAB node is handed over to the second DU of the IAB donor.

In this way, the IAB node updates an F1 interface TNL association as soon as possible after the handover is completed, to restore, as soon as possible, a capability of providing a service for a terminal device, and reduce impact on a service latency of the terminal device.

In a possible design, the first IAB node generates, by using the first IP address, the first transport network layer association information between the first IAB node and the CU of the second IAB donor.

In this way, the IAB node communicates with the CU of the IAB donor by using the first IP address as soon as possible after the handover is completed, thereby reducing the impact, caused by the handover of the IAB node, on the service latency of the terminal device served by the IAB node.

In a possible design, the first message further includes an IP address of the CU of the second IAB donor, and the IP address of the CU of the second IAB donor is used by the first IAB node to perform control plane communication with the CU of the second IAB donor, and/or the IP address of the CU of the IAB donor is used by the first IAB node to determine the first transport network layer association information between the first IAB node and the CU of the IAB donor.

In this way, the IAB node may communicate with the CU of the IAB donor by using the first IP address as soon as possible after the handover is completed, thereby reducing the impact, caused by the handover of the IAB node, on the service latency of the terminal device served by the IAB node.

According to a third aspect, this application provides a communication method. The method is applicable to a scenario in which a first IAB node is handed over, in a service range of a CU of a same IAB donor, from a first DU of the IAB donor to a second DU of the IAB donor. The method includes: A CU of an IAB donor sends a first message to a first IAB node, where the first message indicates the first IAB node to be handed over from a first parent node to a second parent node. The first parent node is a first DU of the IAB donor, or the first parent node is connected to the CU of the IAB donor through a first DU of the IAB donor. The second parent node is a second DU of the IAB donor, or the second parent node is connected to the CU of the IAB donor through a second DU of the IAB donor. The first message includes a first IP address of the first IAB node.

The CU of the IAB donor determines, based on the first IP address, first transport network layer association information between the first IAB node and the CU of the IAB donor after the first IAB node is handed over to the second parent node. The CU of the IAB donor updates control plane context information of a first interface based on the first transport network layer association information, where the first interface may be an F1 interface between the first IAB node and the IAB donor.

In a possible design, the CU of the IAB donor sends a fourth message to the first IAB node, where the fourth message includes indication information, or a third message includes the indication information. The indication information indicates that an occasion for the first IAB node to determine the first transport network layer association information is after the first IAB node is handed over to the second parent node.

In this way, the IAB node updates an F1 interface TNL association as soon as possible after the handover is completed, to restore, as soon as possible, a capability of providing a service for a terminal device, and reduce impact on a service latency of the terminal device.

In a possible design, the CU of the IAB donor establishes, by using the first IP address, the first transport network layer association information between the first IAB node and the CU of the IAB donor. Alternatively, the CU of the IAB donor obtains the first transport network layer association information by adding the first IP address to second transport network layer association information, where the second transport network layer association information is transport network layer association information between the first IAB node and the CU of the IAB donor before the first IAB node is handed over to the second parent node.

In this way, the CU of the IAB donor may update TNL association information in the CU of the IAB donor, to avoid introduction of a large quantity of context update signaling due to the handover of the IAB node and avoid the impact on the service latency of UE.

In a possible design, the first message further includes an IP address of the CU of the IAB donor, and the IP address of the CU of the IAB donor is used by the first IAB node to perform control plane communication with the CU of the IAB donor, and/or the IP address of the CU of the IAB donor is used by the first IAB node to determine the first transport network layer association information between the first IAB node and the CU of the IAB donor.

In this way, the IAB node can communicate with the CU of the IAB donor by using the first IP address as soon as possible after the handover is completed, thereby reducing the impact, caused by the handover of the IAB node, on the service latency of the terminal device served by the IAB node.

In a possible design, the first IP address is obtained from an IP address pool of the CU of the IAB donor, or is obtained from the second DU of the IAB donor, or is obtained from an operation, administration, and maintenance OAM entity, or is obtained from a DHCP server.

According to a fourth aspect, an embodiment of this application provides a communication method. The method is applicable to a scenario in which a first IAB node is handed over from a DU of a first IAB donor to a DU of a second IAB donor, that is, the first IAB node is connected to different IAB donors before and after the handover. The method includes: A CU of a first IAB donor sends a first message to a CU of a second IAB donor, where the first message includes an identifier of a first IAB node, and the first message is for requesting a first IP address. The CU of the first IAB donor receives a second message from the CU of the second IAB donor, where the second message includes the first IP address allocated to the first IAB node. The CU of the first IAB donor sends a third message to the first IAB node, where the third message indicates the first IAB node to be handed over from a first parent node to a second parent node. The first parent node is a DU of the first IAB donor, or the first parent node is connected to the CU of the first IAB donor through a DU of the first IAB donor. The second parent node is a DU of the second

IAB donor, or the second parent node is connected to the CU of the second IAB donor through a DU of the second IAB donor. The third message includes the first IP address of the first IAB node.

In this embodiment of this application, when a parent node of the first IAB node is changed due to IAB topology update, the first IAB node obtains the first IP address, and updates the control plane context between the IAB node and the IAB donor based on the first IP address, to avoid a service latency and signaling overheads caused by F1 interface reestablishment. After the handover is completed, the IAB node performs F1 interface communication with the CU of the IAB donor by obtaining the first IP address. In this way, the IAB node can communicate with the CU of the IAB donor by using the first IP address as soon as possible after the handover is completed, thereby reducing impact on a service latency of a terminal device served by the IAB node.

In a possible embodiment, the first message is a handover request message.

In another possible embodiment, the first message further includes user plane context information and/or control plane context information of a first interface between the first IAB node and the CU of the first IAB donor. The first interface may be an F1 interface between the first IAB node and the second IAB donor.

In a possible embodiment, a CU of a first IAB donor sends fourth information to a first IAB node, where the fourth information includes a first IP address of the first IAB node, and the fourth message indicates the first IAB node to be handed over from a first parent node to a second parent node.

The first parent node is a DU of the first IAB donor, or the first parent node is a second IAB node connected to the CU of the first IAB donor through a DU of the first IAB donor. The second parent node is a DU of a second IAB donor, or the second parent node is a third IAB node connected to a CU of a second IAB donor through a DU of the second IAB donor.

In a possible embodiment, the CU of the first IAB donor sends a message including indication information to the first IAB node. Alternatively, the third message includes the indication information. The indication information indicates that an occasion for the first IAB node to determine first transport network layer association information is after the first IAB node is handed over to the DU of the second IAB donor.

In this way, the IAB node updates an F1 interface TNL association as soon as possible

after the handover is completed, to restore, as soon as possible, a capability of providing a service for the terminal device, and reduce the impact on the service latency of the terminal device.

According to a fifth aspect, an embodiment of this application provides a communication method. The method is applicable to a scenario in which a first IAB node is handed over from a DU of a first IAB donor to a DU of a second IAB donor, that is, the first IAB node is connected to different IAB donors before and after the handover. The method includes: A CU of a second IAB donor receives a first message from a CU of a first IAB donor, where the first message includes an identifier of a first IAB node, and the first message is for requesting a first internet protocol IP address. The CU of the second IAB donor sends a second message to the CU of the first IAB donor, where the second message includes a first IP address allocated to the first IAB node. The CU of the second IAB donor determines, based on the first IP address, first transport network layer association information between the first IAB node and the CU of the second IAB donor after the first IAB node is handed over to a second parent node. The CU of the second IAB donor updates control plane context information of a first interface based on the first transport network layer association information, where the first interface is an interface between the first IAB node and the CU of the second IAB donor.

In this embodiment of this application, when a parent node of the first IAB node is changed due to IAB topology update, the first IAB node obtains the first IP address, and updates the control plane context between the IAB node and the IAB donor based on the first IP address, to avoid a service latency and signaling overheads caused by F1 interface reestablishment.

In a possible embodiment, the CU of the second IAB donor generates, by using the first IP address, the first transport network layer association information between the first IAB node and the CU of the second IAB donor.

In this way, the IAB node updates an F1 interface TNL association as soon as possible after the handover is completed, to restore, as soon as possible, a capability of providing a service for a terminal device, and reduce impact on the service latency of the terminal device.

In a possible embodiment, the first message is a handover request message.

In a possible embodiment, the first message further includes user plane context information and/or control plane context information of the first interface between the first IAB node and the CU of the first IAB donor. The first interface may be an F1 interface between the first IAB node and the second IAB donor.

In a possible embodiment, the CU of the second IAB donor determines control plane context information corresponding to the identifier of the first IAB node. The CU of the second IAB donor replaces second transport network layer association information in the control plane context information with the first transport network layer association information, where the second transport network layer association information is transport network layer association information between the first IAB node and the CU of the IAB donor before the first IAB node is handed over to the second parent node.

In this case, in a scenario in which an IAB node is handed over between nodes of different IAB donors, F1 interface contexts of some or all IAB nodes may be obtained in advance, thereby avoiding a large quantity of signaling required for reestablishing an F1 interface and corresponding control plane and user plane contexts after the handover, and avoiding the impact on the service latency of a terminal.

In a possible embodiment, the first IP address is obtained from an IP address pool of the CU of the second IAB donor, or is obtained from a DU function entity of the second IAB donor, or is obtained by the CU of the second IAB donor from an operation, administration, and maintenance OAM entity, or is obtained by the CU of the second IAB donor from a DHCP server.

According to a sixth aspect, this application provides a communication method. The method is applicable to a scenario in which a first IAB node is handed over, in a service range of a CU of a same IAB donor, from a first DU of the IAB donor to a second DU of the IAB donor. The method includes: A CU of an IAB donor receives a control plane message from a first IAB node, where the control plane message includes a first IP address and a second IP address. The first IP address is an IP address of the first IAB node that is used when the first IAB node communicates with the CU of the IAB donor through a first parent node. The second IP address is an IP address of the first IAB node that is used when the first IAB node communicates with the CU of the IAB donor through a second parent node. The first parent node is a first DU of the IAB donor, or the first parent node is connected to the CU of the IAB donor through a first DU of the IAB donor. The second parent node is a second DU of the IAB donor, or the second parent node is connected to the CU of the IAB donor through a second DU of the IAB donor. The CU of the IAB donor replaces the first IP address in user plane downlink tunnel endpoint information of a first interface with the second IP address.

In this embodiment of this application, according to the method, the CU of the IAB donor replaces, in batches, downlink tunnel information in an F1-U context based on the control plane message, to update a user plane context of a terminal device, and avoid a service latency and signaling overheads caused by F1 interface reestablishment.

According to a seventh aspect, this application provides a communication method. The method is applicable to a scenario in which a first IAB node is handed over, in a service range of a CU of a same IAB donor, from a first DU of the IAB donor to a second DU of the IAB donor. The method includes: A first IAB node receives a control plane message from a CU of an IAB donor, where the control plane message includes a first IP address and a second IP address. The first IP address is an IP address of the CU of the IAB donor that is used when the first IAB node communicates with the CU of the IAB donor through a first parent node. The second IP address is an IP address of the CU of the IAB donor that is used when the first IAB node communicates with the CU of the IAB donor through a second parent node. The first parent node is a first DU of the IAB donor, or the first parent node is connected to the CU of the IAB donor through a first DU of the IAB donor. The second parent node is a second DU of the IAB donor, or the second parent node is connected to the CU of the IAB donor through a second DU of the IAB donor. After the first IAB node is handed over from the first parent node to the second parent node, the first IAB node replaces the first IP address in user plane uplink tunnel endpoint information of an F1 interface with the second IP address.

In this embodiment of this application, according to the method, the IAB node replaces, in batches, downlink tunnel information in an F1-U context based on the signaling, to update a user plane context of a terminal device, and avoid a service latency and signaling overheads caused by F1 interface reestablishment.

According to an eighth aspect, this application provides a communication method. The method is applicable to a scenario in which a first IAB node is handed over, in a service range of a CU of a same IAB donor, from a first DU of the IAB donor to a second DU of the IAB donor. The method includes: A CU-UP of an IAB donor receives a control plane message from a CU-CP of the IAB donor, where the control plane message includes a first IP address and a second IP address. The first IP address is an IP address of a first IAB node that is used when the first IAB node communicates with the CU-UP of the IAB donor through a first parent node. The second IP address is an IP address of the first IAB node that is used when the first IAB node communicates with the CU-UP of the IAB donor through a second parent node. The first parent node is a first DU of the IAB donor, or the first parent node is connected to the CU-UP of the IAB donor through a first DU of the IAB donor. The second parent node is a second DU of the IAB donor, or the second parent node is connected to the CU-UP of the IAB donor through a second DU of the IAB donor. The CU-UP of the IAB donor replaces the first IP address in user plane downlink tunnel endpoint information of an F1 interface with the second IP address.

In this embodiment of this application, the IAB donor CU-UP replaces, in batches, downlink tunnel information in an F1-U context based on the control plane message, to update the F1-U context of a terminal device, and avoid a large quantity of signaling overheads required for updating in a conventional technology.

According to a ninth aspect, this application provides a communication method. The method includes: A relay node receives a first message from a CU of a donor node through a first DU of the donor node, where the first message includes an IP address of the relay node. The relay node determines, based on the IP address, transport network layer association information between the relay node and the CU when the relay node is connected to the CU through a second DU of the donor node. The relay node updates control plane context information of a first interface based on the transport network layer association information, where the first interface is an interface between the relay node and the CU, the first DU is a source DU during relay node handover, and the second DU is a target DU during relay node handover.

In this embodiment of this application, when a parent node of a first IAB node is changed due to IAB topology update, the first IAB node obtains a first IP address, and updates a control plane context between an IAB node and an IAB donor based on the first IP address, to avoid a service latency and signaling overheads caused by F1 interface reestablishment. After the handover is completed, the IAB node performs F1 interface communication with a CU of the IAB donor by using the first IP address. In this way, the IAB node may communicate with the CU of the IAB donor by using the first IP address as soon as possible after the handover is completed, thereby reducing impact on the service latency of a terminal device served by the IAB node.

According to a tenth aspect, this application provides a communication method. The method includes: A relay node receives a first message from a target donor node through a source donor node, where the first message includes an IP address of the relay node. The relay node determines transport network layer association information between the relay node and the target donor node based on the IP address. The relay node updates control plane context information of a first interface based on the transport network layer association information. The first interface is an interface between the relay node and the target donor node, the source donor node is a source donor node during relay node handover, and a target donor node is a target donor node during relay node handover.

In this embodiment of this application, the source donor node includes a CU of a donor, and optionally, may alternatively include a DU of a donor. When a parent node of a first IAB node is changed due to IAB topology update, the first IAB node obtains a first IP address, and updates a control plane context between an IAB node and an IAB donor based on the first IP address, to avoid a service latency and signaling overheads caused by F1 interface reestablishment.

According to an eleventh aspect, this application provides a communication apparatus. The communication apparatus may be a first IAB node or a chip disposed inside a first IAB node. The communication apparatus has a function of implementing the first aspect. For example, the communication apparatus includes a corresponding module, unit, or means (means) for performing the steps in the first aspect. The function, the unit, or the means may be implemented by software or hardware, or may be implemented by hardware executing corresponding software.

In a possible design, the communication apparatus includes a processing unit and a communication unit. The communication unit may be configured to receive and send a signal, to implement communication between the communication apparatus and another apparatus. For example, the communication unit is configured to receive first information from a network device. The processing unit may be configured to perform some internal operations of the communication apparatus. Functions performed by the processing unit and the communication unit may correspond to the steps performed by the first IAB node in the foregoing aspects.

In a possible design, the communication apparatus includes a processor, and may further include a transceiver. The transceiver is configured to receive and send a signal, and the processor executes program instructions, to complete the method according to any one of the possible designs or implementations of the first aspect. The communication apparatus may further include one or more memories. The memory is configured to be coupled to the processor. The one or more memories may be integrated with the processor, or may be disposed independent of the processor. This is not limited in this application. The memory may store a necessary computer program or necessary instructions for implementing the functions in the first aspect. The processor may execute the computer program or the instructions stored in the memory. When the computer program or the instructions is/are executed, the communication apparatus is enabled to implement the method according to any one of the possible designs or implementations of the first IAB node in the foregoing aspects.

In a possible design, the communication apparatus includes a processor and a memory. The memory may store a necessary computer program or necessary instructions for implementing the functions in the first aspect. The processor may execute the computer program or the instructions stored in the memory. When the computer program or the instructions is/are executed, the communication apparatus is enabled to implement the method according to any one of the possible designs or implementations of the first IAB node in the foregoing aspects.

In a possible design, the communication apparatus includes at least one processor and an interface circuit. The at least one processor is configured to: communicate with another apparatus through the interface circuit, and perform the method performed by the first IAB node according to any one of the possible designs or implementations of the first aspect.

According to a twelfth aspect, this application provides a communication apparatus. The communication apparatus may be a network device or a chip disposed inside a network device. The communication apparatus has a function of implementing the foregoing aspects of the IAB donor. For example, the communication apparatus includes a corresponding module, unit, or means for performing the steps in the second aspect. The function, the unit, or the means may be implemented by software or hardware, or may be implemented by hardware executing corresponding software.

In a possible design, the communication apparatus includes a processing unit and a communication unit. The communication unit may be configured to receive and send a signal, to implement communication between the communication apparatus and another apparatus. For example, the communication unit is configured to send a first message to a first IAB node. The processing unit may be configured to perform some internal operations of the communication apparatus. Functions performed by the processing unit and the communication unit may correspond to the steps in the foregoing aspects of the IAB donor.

In a possible design, the communication apparatus includes a processor, and may further include a transceiver. The transceiver is configured to receive and send a signal, and the processor executes program instructions, to complete the method according to any one of the possible designs or implementations of the second aspect. The communication apparatus may further include one or more memories. The memory is configured to be coupled to the processor. The one or more memories may be integrated with the processor, or may be disposed independent of the processor. This is not limited in this application. The memory may store a necessary computer program or necessary instructions for implementing the functions in the second aspect. The processor may execute the computer program or the instructions stored in the memory. When the computer program or the instructions is/are executed, the communication apparatus is enabled to implement the method according to any one of the possible designs or implementations in the foregoing aspects of the IAB donor.

In a possible design, the communication apparatus includes a processor and a memory. The memory may store a necessary computer program or necessary instructions for implementing the functions in the second aspect. The processor may execute the computer program or the instructions stored in the memory. When the computer program or the instructions is/are executed, the communication apparatus is enabled to implement the method according to any one of the possible designs or implementations in the foregoing aspects of the IAB donor.

In a possible design, the communication apparatus includes at least one processor and an interface circuit. The at least one processor is configured to: communicate with another apparatus through the interface circuit, and perform the method according to any one of the possible designs or implementations in the foregoing aspects of the IAB donor.

According to a thirteenth aspect, this application provides a computer-readable storage medium. The computer storage medium stores computer-readable instructions. When the computer-readable instructions are read and executed on a computer, the computer is enabled to perform the method according to any one of the possible designs in the foregoing aspects.

According to a fourteenth aspect, this application provides a computer program product. When the computer program product is read and executed on a computer, the computer is enabled to perform the method according to any one of the possible designs in the foregoing aspects.

According to a fifteenth aspect, this application provides a chip. The chip includes a processor. The processor is coupled to a memory, and is configured to read and execute a software program stored in the memory, to implement the method according to any one of the possible designs in the foregoing aspects.

These aspects or other aspects of this application are clearer and more comprehensible in descriptions of the following embodiments.

### BRIEF DESCRIPTION OF DRAWINGS

FIG. 1A and FIG. 1B are a schematic diagram of a network architecture according to an embodiment of this application;

FIG. 2A and FIG. 2B are a schematic diagram of another network architecture according to an embodiment of this application;

FIG. 3A and FIG. 3B are a schematic diagram of a structure of a protocol stack according to an embodiment of this application;

FIG. 4A and FIG. 4B are a schematic diagram of an applicable scenario according to an embodiment of this application;

FIG. 5 is a schematic flowchart of a first communication method according to an embodiment of this application;

FIG. 6 is a detailed schematic flowchart of another communication method according to an embodiment of this application;

FIG. 7A and FIG. 7B are a schematic diagram of an applicable scenario according to an embodiment of this application;

FIG. 8 is a detailed schematic flowchart of another communication method according to an embodiment of this application;

FIG. 9 is a detailed schematic flowchart of another communication method according to an embodiment of this application;

FIG. 10 is a detailed schematic flowchart of another communication method according to an embodiment of this application;

FIG. 11A and FIG. 11B are a detailed schematic flowchart of another communication method according to an embodiment of this application;

FIG. 12A and FIG. 12B are a detailed schematic flowchart of another communication method according to an embodiment of this application;

FIG. 13 is a possible example block diagram of an apparatus according to an embodiment of this application;

FIG. 14 is a schematic diagram of a structure of a terminal device according to an embodiment of this application; and

FIG. 15 is a schematic diagram of a structure of a network device according to an embodiment of this application.

### DESCRIPTION OF EMBODIMENTS

The following further describes in detail embodiments of this application with reference to the accompanying drawings.

Embodiments of this application may be applied to various mobile communication systems, for example, a first radio (new radio, NR) system, a long term evolution (long term evolution, LTE) system, an advanced long term evolution (advanced long term evolution, LTE-A) system, an evolved long term evolution (evolved long term evolution, eLTE) system, a future communication system, and another communication system. Specifically, this is not limited herein.

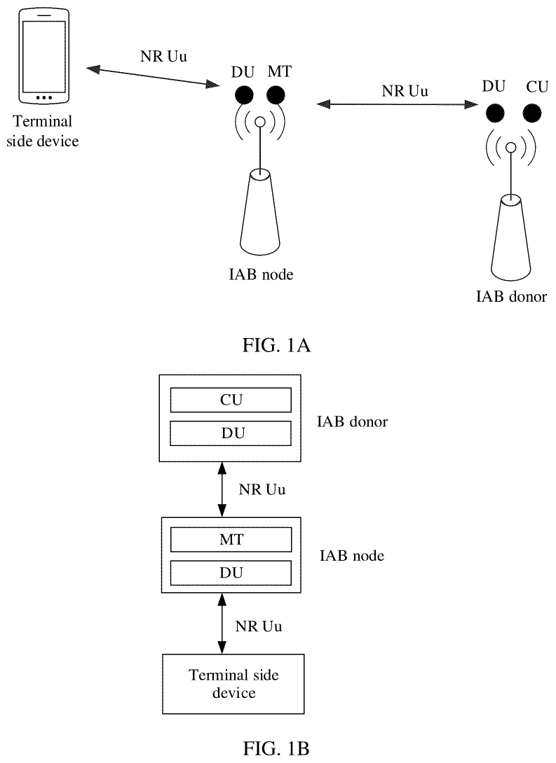

For ease of understanding embodiments of this application, a communication system shown in FIG. 1A is first used as an example to describe in detail a communication system applicable to embodiments of this application. FIG. 1A is a schematic diagram of a communication system to which a communication method in embodiments of this application is applicable. As shown in FIG. 1A, the communication system includes an IAB donor gNodeB, an IAB node, and a terminal device. FIG. 1B is another expression form of the communication system shown in FIG. 1A. Meanings of substantive expressions are consistent, and details are not described herein again.

In addition, FIG. 1A and FIG. 1B further show names of interfaces between devices, for example, a radio interface (which is named as an NR Uu interface in the figure) between the terminal device and the IAB node and a radio interface (which may be referred to as an NR radio backhaul interface, and is named as an NR Uu interface in the figure because communication through the interface is performed also based on an NR Uu interface protocol) between the IAB node and the IAB donor gNodeB. The names of these interfaces are merely examples, and do not represent a limitation on the interfaces. When a release of the communication system changes, a corresponding name may also be replaced with a name of a corresponding function in another radio communication network.

An IAB network shown in FIG. 1A supports multi-hop networking. For example, there may be one or more intermediate IAB nodes between the IAB node and the IAB donor gNodeB shown in FIG. 1A and FIG. 1B.

The IAB network shown in FIG. 1A supports both multi-hop networking and multi-connection networking. There may be at least one transmission path including a plurality of links between the terminal device served by the IAB node and the IAB donor. Alternatively, there may be one or more transmission paths between the IAB node and the IAB donor, and each transmission path may include one or more IAB nodes. On a transmission path, each IAB node considers an adjacent node that provides an access and backhaul service for the IAB node as a parent node, and correspondingly, each IAB node may be considered as a child node of the parent node of the IAB node. For example, in the scenarios shown in FIG. 1A and FIG. 1B, a parent node of the IAB node is the IAB donor, and the IAB donor considers the IAB node as a child node.

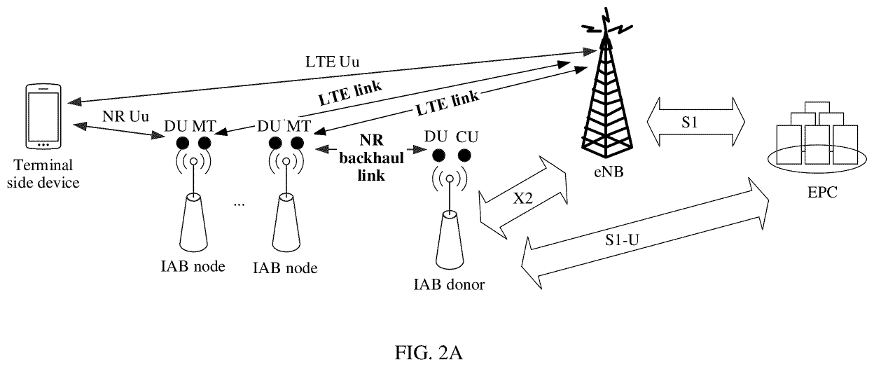

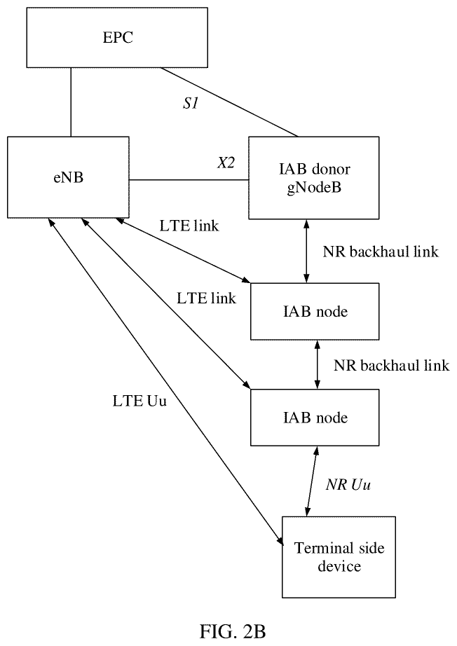

It should be noted that the IAB networking scenario shown in FIG. 1A is merely an example. In an IAB scenario combining multi-hop and multi-connection, there may be another connection form. For example, this application may be further applied to a dual connectivity scenario. Details may be shown in FIG. 2A. FIG. 2A shows a schematic diagram of a network architecture of an E-UTRAN NR dual connectivity (E-UTRAN NR Dual Connectivity, EN-DC) system. As shown in FIG. 2A, the communication system includes a packet data core network (evolved packet core, EPC) device, a base station (eNB) in an LTE system, an IAB donor, IAB nodes, and a terminal device. An EN-DC networking manner shown in FIG. 2A may also be referred to as non-standalone (non-standalone, NSA) networking of an IAB network. FIG. 2B is another expression form of the communication system shown in FIG. 2A. Meanings of substantive expressions are consistent, and details are not described herein again.

In FIG. 2A, the base station (the eNB in the figure) in the LTE system is a master base station (which therefore may also be referred to as a Master eNB, MeNB for short), provides an LTE air interface (LTE Uu) connection for the IAB nodes, and performs user plane data transmission and control plane data transmission with the core network EPC through an S1 interface. The IAB donor gNodeB is a secondary base station, provides an NR air interface (NR Uu) connection for the IAB nodes, and performs user plane data transmission with the core network EPC through the SI interface. Similarly, the terminal device also supports dual connectivity. UE is connected to the master base station (the eNB) through the LTE Uu interface, and is connected to the secondary base station (the IAB nodes or the IAB donor gNodeB) through the NR Uu interface.

It should be noted that FIG. 2A is merely a networking example, and NSA networking of the IAB network also supports multi-hop IAB networking. For example, the terminal device in FIG. 2A and FIG. 2B may be connected to the IAB donor gNodeB through two or more IAB nodes, that is, the IAB nodes may be connected to the IAB donor gNodeB over a multi-hop backhaul link. The NSA networking of the IAB network also supports single-hop IAB networking. For example, the terminal device in FIG. 2A and FIG. 2B may be connected to the IAB donor gNodeB through one IAB node. In addition, when being connected to the eNB, the IAB node communicates with the eNB over a single-hop LTE link.

In addition, it should be noted that a dual connectivity scenario to which this application is applicable may be the EN-DC networking scenario shown in FIG. 2A and FIG. 2B, or may include dual connectivity including an IAB network and an IAB network, or may include dual connectivity including an IAB network and another future communication system. The foregoing example does not constitute any limitation on the scenario.

In embodiments of this application, the IAB node may also be referred to as a relay node (relay node, RN). For ease of description, the IAB node is uniformly used for reference below. The IAB node may include at least one mobile terminal (mobile terminal, MT) unit and at least one distributed unit (distributed unit, DU). In FIG. 1A and FIG. 2A, only an example in which the IAB node includes one MT unit and one DU is used for description. The MT unit in the IAB node enables the IAB to serve as a terminal to communicate with a parent node of the IAB node and an IAB donor node, and has a function of user equipment (user equipment, UE). The DU in the IAB node provides an access service for the terminal device or another IAB node attached to the DU, and may also communicate with the IAB donor node through an F1 interface. The MT in the IAB node may also be referred to as an MT function entity in the IAB node, and the DU in the IAB node may also be referred to as a DU function entity in the IAB node. For ease of description, the MT in the IAB node and the MT function entity in the IAB node each are briefly referred to as an “IAB node MT”, and the DU in the IAB node and the DU function entity in the IAB node each are briefly referred to as an “IAB node DU”. The IAB node may provide a radio access service for the terminal device, and service data or control information of the terminal device is transmitted from the IAB node to the IAB donor (IAB donor) or a network side device over a wireless backhaul link.

The IAB donor may be an access network element having a complete base station function, or may be an access network element in a form in which a centralized unit (centralized unit, CU) is split from a distributed unit (distributed unit, DU). The CU in the IAB donor may also be referred to as a CU function entity in the IAB donor, and the DU in the IAB donor may also be referred to as a DU function entity in the IAB donor.

For ease of description, in embodiments of this application, the CU in the IAB donor and the CU function entity in the IAB donor each are briefly referred to as a CU of an IAB donor (also referred to as an IAB-donor-CU), and the DU in the IAB donor and the DU function entity in the IAB donor each are briefly referred to as a DU of an IAB donor (also referred to as an IAB-donor-DU). The CU of the IAB donor may alternatively be in a form in which a control plane (control plane, CP) is split from a user plane (user plane, UP). For example, one CU of an IAB donor includes one CU-CP (also referred to as an IAB-donor-CU-CP) and a plurality of CU-UPs (also referred to as IAB-donor-CU-UPs). This is not limited in embodiments of this application.

The F1 interface in embodiments of this application is an interface between the DU of the IAB node and the IAB donor gNodeB, an interface between the DU of the IAB node and the CU of the IAB donor gNodeB, or an interface between the IAB node and the IAB donor gNodeB. The F1 interface may also be referred to as an F1* interface or the like, which may be uniformly referred to as an F1 interface in embodiments of this application for ease of description, but the name is not limited.

It should be noted that the F1 interface may also be an interface between function entities in a device. For example, for a base station including a DU and a CU, the F1 interface may be an interface between the DU in the base station and the CU in the base station.

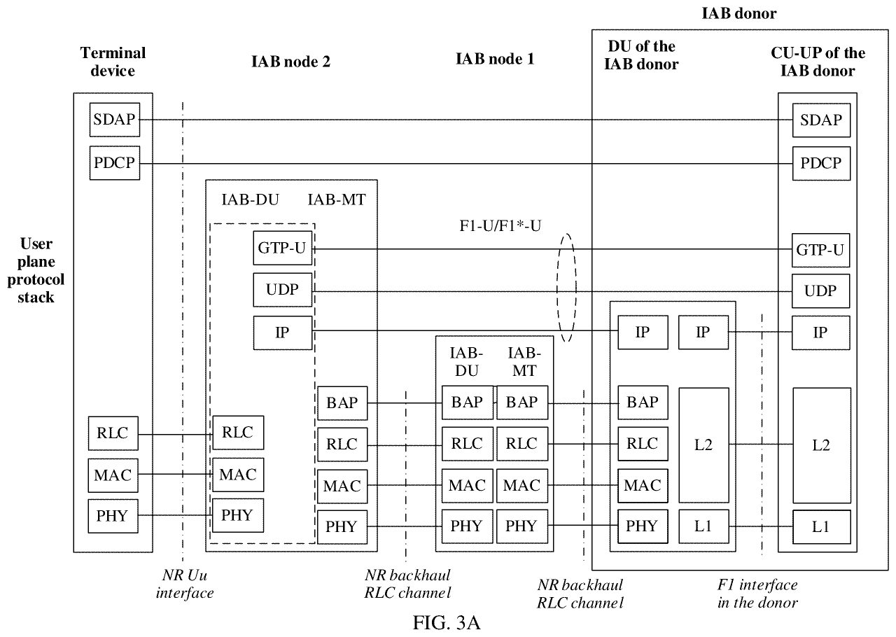

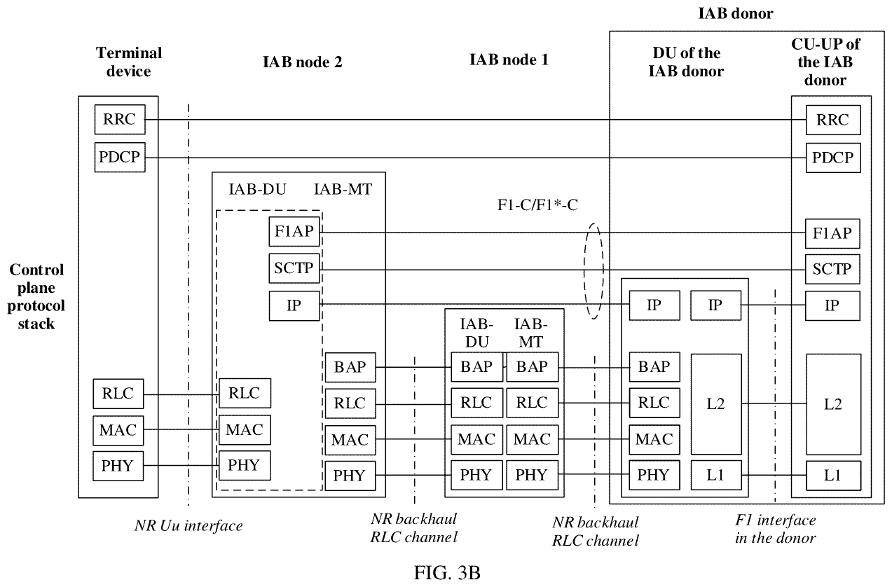

The F1 interface in embodiments of this application supports a user plane protocol and a control plane protocol. For example, FIG. 3A is a schematic diagram of a protocol stack of a user plane protocol according to an embodiment of this application. In FIG. 3A, an example in which a link between a terminal device and an IAB donor includes a terminal device, an IAB node 2, an IAB node 1, and an IAB donor is used for description. The IAB donor includes a DU of the IAB donor (IAB-donor-DU) and a CU of the IAB donor (IAB-donor-CU). The CU of the IAB donor includes a control plane functional unit of the CU of the IAB donor (IAB-donor-CU-CP) and a user plane functional unit of the CU of the IAB donor (IAB-donor-CU-UP). Because FIG. 3A shows an example of a user plane protocol stack, only the IAB-donor-CU-UP part is shown in the IAB. Correspondingly, only the IAB-donor-CU-CP part is shown in a control plane protocol stack in FIG. 3B.

In FIG. 3A, peer protocol layers between the terminal device and the IAB donor include a service data application protocol (Service Data Adaptation Protocol, SDAP) layer and a packet data convergence protocol (packet data convergence protocol, PDCP) layer. Peer protocols between the terminal device and the IAB node 2 include a radio link control (radio link control, RLC) layer, a medium access control (medium access control, MAC) layer, and a physical (Physical, PHY) layer.

Peer protocols that are between the IAB node 2 and the IAB donor and that are on a user plane of an F1 interface include a general packet radio service (General Packet Radio Service, GPRS) tunneling protocol user plane (GPRS Tunneling Protocol User Plane, GTP-U) layer, a user datagram protocol (user datagram protocol, UDP) layer, and an internet protocol (internet protocol, IP) layer. Optionally, the protocol layers on the user plane of the F1 interface further include a PDCP layer and/or an IP security (IP Security, IPsec for short) layer. In a possible implementation, the IPsec layer or the PDCP layer is located above the IP layer and below the GTP-U layer.

Peer protocol layers between the IAB node 2 and the IAB node 1 include a backhaul adaptation protocol (Backhaul Adaptation Protocol, BAP) layer, an RLC layer, a MAC layer, and a PHY layer. Correspondingly, peer protocols between the IAB node 1 and the IAB donor include a BAP layer, an RLC layer, a MAC layer, and a PHY layer.

With reference to FIG. 3A, for example, FIG. 3B is a schematic diagram of a protocol stack of a control plane protocol according to an embodiment of this application.

In FIG. 3B, peer protocols between a terminal device and an IAB donor include a radio resource control (radio resource control, RRC) layer and a PDCP layer. Peer protocols between the terminal device and an IAB node 2 include an RLC layer, a MAC layer, and a PHY layer.

Peer protocols that are between the IAB node 2 and the IAB donor and that are on a control plane of an F1 interface include an F1 application layer protocol (F1 application protocol, F1AP) layer, a stream control transport protocol (stream control transport protocol, SCTP) layer, and an IP layer. Optionally, the control plane protocol layer of the F1 interface further includes one or more of a PDCP layer, an IPsec layer, and a datagram transport layer security (datagram transport layer security, DTLS for short) layer. In a possible implementation, the IPsec layer, the PDCP layer, or the DTLS layer is located above the IP layer and below the F1AP layer.

Peer protocols between the IAB node 2 and an IAB node 1 include a BAP layer, an RLC layer, a MAC layer, and a PHY layer. Correspondingly, peer protocols between the IAB node 1 and the IAB donor include a BAP layer, an RLC layer, a MAC layer, and a PHY layer. The BAP layer has at least one of the following capabilities: adding, to a data packet,

routing information (Routing information) that can be identified by a radio backhaul node; performing routing selection based on the routing information that can be identified by the radio backhaul node; adding, to the data packet, identification information that can be identified by the radio backhaul node and that is related to a quality of service (quality of service, QoS for short) requirement; performing QoS mapping on a plurality of links including the radio backhaul node for the data packet; adding data packet type indication information to the data packet; sending stream control feedback information to a node having a stream control capability; and sending backhaul link failure indication information to a child node. It should be noted that a name of a protocol layer having these capabilities is not necessarily a BAP layer. A person skilled in the art may understand that any protocol layer having these capabilities may be understood as the BAP layer in embodiments of this application. The routing information that can be identified by an IAB node may be one or more types of information such as an identifier of a terminal, an identifier of an IAB node accessed by the terminal device, an identifier of a donor node, an identifier of a Donor-DU, an identifier of a Donor-CU, and an identifier of a transmission path.

For example, the node having the stream control capability may be a node providing a backhaul service for an IAB node, and may be, for example, a donor node, a Donor-DU, a Donor-CU, or a parent node of the IAB node. Content of the stream control feedback information may include one or more types of the following information: a cache status and a load degree of an IAB node, a status (for example, a link blockage (blockage), link resumption (resume), or link quality information) of a link including the IAB node, a bandwidth and a transmission latency of the link including the IAB node, a sequence number of a data packet lost at the IAB node, a sequence number of a data packet successfully sent by the IAB node to a terminal or a child node of the terminal, and the like.

In addition, in a possible case, a function of the BAP layer may alternatively be extended from a function or functions of any one or more layers (for example, an RLC layer, a MAC layer, and a PDCP layer) included in a layer 2 without any additional protocol layer.

It should be noted that, for functions and effects of the protocol layers described above, refer to descriptions in an existing standard. Details are not described herein.

It should be noted that the IAB node MT may have a protocol stack of UE. For a communication protocol stack between the IAB node MT and the IAB donor and a communication protocol stack between the IAB node MT and the parent node, refer to the protocol stacks of UE in FIG. 3A and FIG. 3B for understanding. In this case, the IAB node may also have an RRC layer, and may establish an RRC connection with the IAB donor, to perform communication based on the RRC layer.

It may be understood that the protocol stack architectures in the IAB network shown in FIG. 3A and FIG. 3B in embodiments of this application are merely examples. Methods provided in embodiments of this application do not depend on the examples, but the examples make the methods provided in embodiments of this application easier to understand.

In embodiments of this application, a terminal device is a device having a wireless transceiver function, or a chip that can be disposed in the device. The device having the wireless transceiver function may also be referred to as user equipment (user equipment, UE), an access terminal, a user unit, a user station, a mobile station, a remote station, a remote terminal, a mobile device, a user terminal, a user agent, or a user apparatus. During actual application, the terminal device in embodiments of this application may be a mobile phone (mobile phone), a tablet computer (Pad), a computer having a wireless transceiver function, a virtual reality (virtual reality, VR) terminal, an augmented reality (augmented reality, AR) terminal, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), or the like. An application scenario is not limited in embodiments of this application. In this application, the foregoing device having the wireless transceiver function and the chip that can be disposed in the device are collectively referred to as the terminal device.

In embodiments of this application, the network side device may be a radio access device in various standards, for example, an evolved NodeB (evolved NodeB, eNB), a radio network controller (radio network controller, RNC) or a NodeB (NodeB, NB), a base station controller (base station controller, BSC), a base transceiver station (base transceiver station, BTS), a home base station (for example, a home evolved NodeB, or a home NodeB, HNB), a baseband unit (baseband unit, BBU), an access point (access point, AP) in a wireless local area network (wireless local area network) system, a wireless relay node, a wireless backhaul node, a transmission point (transmission reception point, TRP, or transmission point, TP). The network side device may alternatively be a gNB or a transmission point (TRP or TP) in a 5G (NR) system, one or one group of antenna panels (including a plurality of antenna panels) of a base station in a 5G system, or may be a network node that constitutes a gNB or a transmission point, for example, a baseband unit (BBU), or may be a DU under a centralized unit-distributed unit (central unit-distributed, CU-DU) architecture.

A network architecture and a service scenario described in embodiments of this application are intended to describe the technical solutions in embodiments of this application more clearly, and do not constitute any limitation on the technical solutions provided in embodiments of this application. A person of ordinary skill in the art may know that with evolution of the network architecture and emergence of another service scenario, the technical solutions provided in embodiments of this application are also applicable to resolving similar technical problems.

In embodiments of this application, an IAB scenario in a wireless communication network is used as an example to describe some scenarios. It should be noted that the solutions in embodiments of this application may be further applied to another wireless communication network, and a corresponding name may also be replaced with a name of a corresponding function in the another wireless communication network.

The communication method provided in embodiments of this application involves two scenarios: an F1 interface control plane context update scenario and an F1 interface user plane context update scenario. The following describes the F1 interface control plane context update in detail in the following scenario 1 and scenario 2, and describes the F1 interface user plane context update in detail in the following scenario 3, scenario 4, and scenario 5.

### Embodiment 1

Scenario 1: In this embodiment of this application, an IAB donor includes a CU of the IAB donor, a first DU of the IAB donor, and a second DU of the IAB donor. A first IAB node is handed over, in a service range of a CU of a same IAB donor, from the first DU of the IAB donor to the second DU of the IAB donor, that is, the first IAB node is connected to different DUs of the IAB donor before and after the handover. The first IAB node may be an IAB node directly connected to the IAB donor, or may be connected to the IAB donor over a wireless backhaul link having at least one hop.

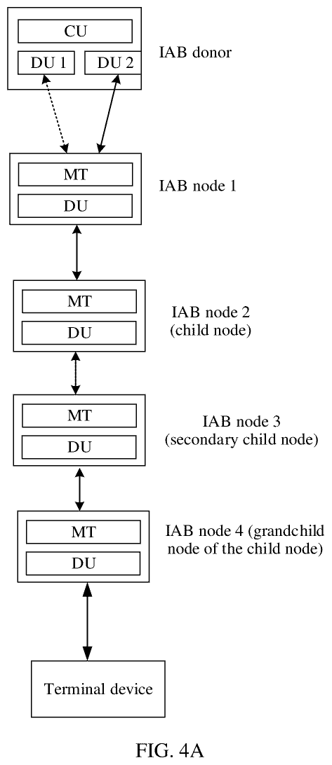

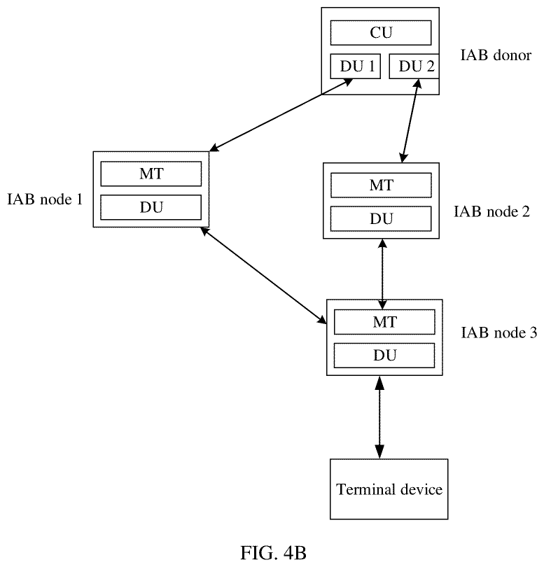

For example, as shown in FIG. 4A, an IAB node 1 is directly connected to a DU 1 of an IAB donor before handover, and the IAB node 1 is directly connected to a DU 2 of the IAB donor after the handover. The first IAB node in the scenario 1 may be the IAB node 1 in FIG. 4A.

For another example, as shown in FIG. 4B, an IAB node 3 is connected to a DU 1 of an IAB donor over a wireless backhaul link having one hop (in other words, through an IAB node 1) before handover, and the IAB node 3 is connected to a DU 2 of the IAB donor over a wireless backhaul link having one hop (in other words, through an IAB node 2) after the handover. The first IAB node in the scenario 1 may be the IAB node 3 in FIG. 4B.

It should be noted that an IAB node 1 whose parent node changes may further have another child node (for example, the child node connected to the IAB node 1 is an IAB node 2), or the IAB node 1 whose parent node changes may further have a secondary child node of another child node (for example, a secondary child node IAB node 3 connected to an IAB node 2, or a grandchild node IAB node 4 of the child node IAB node 2).

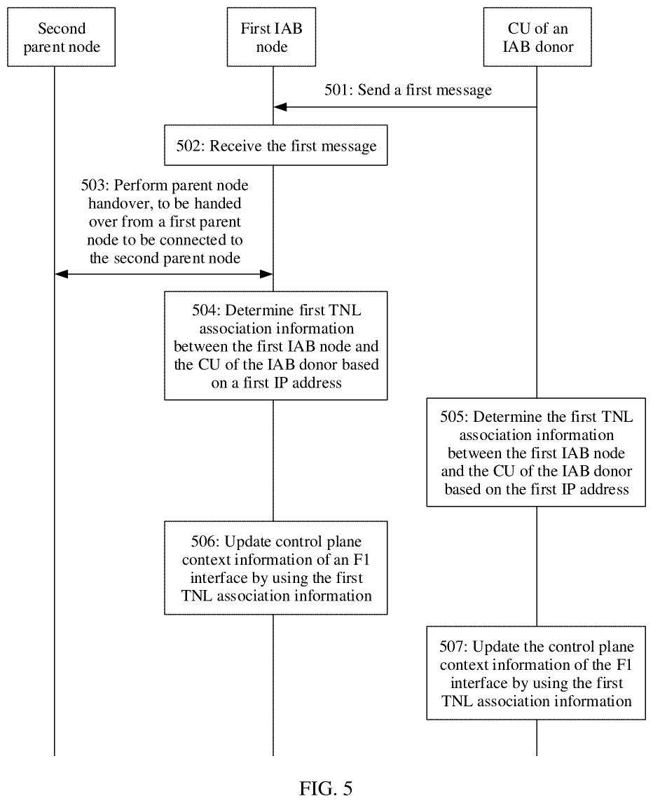

With reference to the foregoing descriptions, FIG. 5 is a schematic flowchart of a first communication method according to an embodiment of this application. Refer to FIG. 5. The method includes the following steps.

Step 501: A CU of an IAB donor sends a first message to a first IAB node.

In a possible case, the CU of the IAB donor may alternatively be replaced with a CU-CP of the IAB donor.

The first message indicates the first IAB node to be handed over from a first parent node to a second parent node. The first parent node may be a first DU of the IAB donor, or the first parent node may be a second IAB node connected to the CU of the IAB donor through a first DU of the IAB donor. The second parent node may be a second DU of the IAB donor, or the second parent node may be a third IAB node connected to the CU of the IAB donor through a second DU of the IAB donor.

For example, the first IAB node is the IAB node 1, the first parent node is the DU 1 of the IAB donor to which the IAB node 1 is connected in FIG. 4A, and the second parent node may be the DU 2 of the IAB donor to which the IAB node 1 is connected in FIG. 4A.

For another example, the first IAB node is the IAB node 3 in FIG. 4B, and the first parent node is the IAB node 1 to which the IAB node 3 is connected in FIG. 4B. The second parent node is the IAB node 2 to which the IAB node 3 is connected in FIG. 4B.

In a possible implementation, the first message may be a higher layer radio resource control (radio resource control, RRC) reconfiguration message. Optionally, when the first parent node is different from the second parent node, the RRC reconfiguration message may include a handover command, or the handover command is the first message, or the first message may be carried in another RRC message.

In another possible implementation, when the first parent node is the same as the second parent node, the first message may include updated route configuration information. For example, the IAB node 2 in FIG. 4A may receive a first message from a CU of the IAB donor, where the first message may include updated route configuration information. The IAB node 2 (which may be specifically an MT part of the IAB node 2) does not need to perform handover in cells served by two different parent nodes, and only needs to update route configuration of a BAP layer of the IAB node 2 based on the received first message, to update a transmission route originally passing through the first parent node to the first DU of the IAB donor as a transmission route passing through the first parent node to the second DU of the IAB donor, and to switch from being connected to the first DU of the IAB donor to being connected to the second DU of the IAB donor.

In a possible implementation, the first message may include a first internet protocol (internet protocol, IP) address allocated to the first IAB node. The first IP address may include one or more IP addresses. The first IP address is used by the first IAB node to communicate with the second DU of the IAB donor after the first IAB node is handed over to the second DU of the IAB donor. A manner of obtaining the first IP address by the CU of the IAB donor is as follows: The first IP address may be obtained from an IP address pool (pool) maintained by the CU of the IAB donor, or the first IP address may be obtained from the second DU of the IAB donor, or the first IP address may be obtained from operation, administration, and maintenance (operation administration and maintenance, OAM), or the first IP address may be requested from a dynamic host configuration protocol (dynamic host configuration protocol, DHCP) server. The first IAB node may update a control plane context between the IAB node and the CU of the IAB donor based on the first IP address. Moreover, the first message carries the first IP address, so that the IAB node can communicate with the CU of the IAB donor by using the first IP address as soon as possible after the handover is completed, thereby reducing a service latency of a terminal device served by the IAB node.

In a possible implementation, the first message may further include an IP address of the CU of the IAB donor, where the IP address is used by the IAB node to perform control plane communication with the CU of the IAB donor; and/or the IP address of the CU of the IAB donor is used by the IAB node to determine first transport network layer (Transport Network Layer, TNL) association information between the first IAB node and the CU of the IAB donor. In this way, the IAB node can communicate with the CU of the IAB donor by using the IP address as soon as possible after the handover is completed, thereby reducing impact, caused by the handover of the IAB node, on the service latency of the terminal device served by the IAB node.

Step 502: The first IAB node receives the first message.

In a possible embodiment, the first message is the RRC reconfiguration message, and the first IAB node receives the RRC reconfiguration message from the CU of the IAB donor. The reconfiguration message includes the handover command, and the handover command may be an information element that specifically requires the first IAB node to perform reconfiguration with sync (reconfiguration with sync), and indicates the first IAB node to be handed over to a cell served by the second parent node. The second parent node may be a cell served by the second DU of the IAB donor.

In another possible embodiment, when the first parent node is the same as the second parent node, the first message received by the first IAB node from the CU of the IAB donor may include the updated route configuration information, indicating configuration of an uplink transmission route from the first IAB node to the second DU of the IAB donor. The updated route configuration information may specifically include any one or more of the following items: one or more BAP layer routing identifiers destined for the second DU of the IAB donor, and a next-hop node identifier (namely, a BAP layer identifier of a parent node of the first IAB node) corresponding to any BAP layer routing identifier. The BAP layer routing identifier destined for the second DU of the IAB donor includes a BAP layer identifier (namely, a BAP address) of the IAB donor (which may be specifically the CU of the IAB donor or the second DU of the IAB donor), and may further include an identifier of a path from the first IAB node to the second DU of the IAB donor. The first message may be specifically an F1AP message, for example, a gNB-CU configuration update (gNB-CU configuration update) message. Alternatively, the first message may be an RRC message, for example, the RRC reconfiguration message.

Step 503: The first IAB node performs parent node handover based on the first message, to be handed over from the first parent node to be connected to the second parent node.

The first parent node is the first DU of the IAB donor, and the second parent node is the second DU of the IAB donor. That is, the first IAB node switches from being connected to the first DU of the IAB donor to being connected to the second DU of the IAB donor.

Specifically, the first IAB node (which may be specifically an MT part of the first IAB node) may perform handover, and send a random access request in a cell served by the second parent node. After receiving a response message from the second parent node, the first IAB node may continue to perform a subsequent access step to complete access to the cell served by the second parent node.

In another possible embodiment, when the first parent node is the same as the second parent node, the first IAB node (which may be specifically the MT part of the first IAB node) does not need to perform handover in cells served by two different parent nodes, and only needs to update route configuration of a BAPlayer of the first IAB node based on the received first message, to update a transmission route originally passing through the first parent node to the first DU of the IAB donor as a transmission route passing through the first parent node to the second DU of the IAB donor, and to switch from being connected to the first DU of the IAB donor to being connected to the second DU of the IAB donor.

Step 504: The first IAB node obtains the first IP address, and determines the first TNL association information between the first IAB node and the CU of the IAB donor based on the first IP address.

In a possible manner, if the first message received by the first IAB node includes the first IP address, the first IAB node obtains the first IP address after receiving the first message in step 501.

In another possible manner, the first IAB node may obtain the first IP address from the OAM. In another possible manner, the first IAB node may obtain the first IP address from the second DU of the IAB donor. In the two cases, the first message may not include the first IP address.

It should be noted that, in this embodiment of this application, TNL association information is information for describing a TNL association, and may specifically include endpoint information of the TNL association (which may also be referred to as a stream control transport protocol (stream control transport protocol, SCTP) association). The endpoint information of the TNL association may be specifically local endpoint information and/or peer endpoint information of the TNL association, and each piece of endpoint information of the TNL association may be specifically an IP address set corresponding to an endpoint. The IP address set includes at least one IP address, and the first IAB node may update the TNL association information by updating the IP address in the IP address set. In this embodiment of this application, the first TNL association information is information for describing a first TNL association, and is TNL association information used when the first IAB node performs connection through the first DU. Second TNL association information is information for describing a second TNL association, and is TNL association information used when the first IAB node performs connection through the second DU. An IP address set in the first TNL association information is different from an IP address set in the second TNL association information. Both the first TNL association and the second TNL association are TNL associations between the first IAB node and the CU of the IAB donor, and the first TNL association and the second TNL association may be two different TNL associations, or the first TNL association is a TNL association obtained by updating endpoint information of the second TNL association.

Specifically, in a possible embodiment, the first IAB node may establish the first TNL association between the first IAB node and the CU of the IAB donor by using the first IP address, and generate the first TNL association information. From the perspective of the first IAB node, a local endpoint of the first TNL association is the first IAB node, and a peer endpoint is the CU of the IAB donor. The first TNL association information includes IP address sets/an IP address set corresponding to the local endpoint and/or the peer endpoint of the first TNL association, and the IP address set corresponding to the local endpoint includes the first IP address.

In another possible embodiment, if the second TNL association has been established between the first IAB node and the CU of the IAB donor before the handover, and the first IAB node maintains the second TNL association information, the first IAB node updates the second TNL association information by using the first IP address, that is, adds the first IP address to an IP address set corresponding to a local endpoint of a TNL association in the second TNL association information, to generate the first TNL association information.

Optionally, before performing step 503, the first IAB node may further receive indication information from the CU of the IAB donor, or the first message may include indication information, where the indication information indicates that an occasion for the first IAB node to determine the first TNL association information is after the first IAB node is handed over to be connected to the second parent node. For example, if the first IAB node sends an RRC reconfiguration complete message to the CU of the IAB donor, it indicates that the first IAB node has been handed over to be connected to the second parent node. The second parent node may be the second DU of the IAB donor, or the third IAB node connected to the CU of the IAB donor through the second DU of the IAB donor. In this way, the IAB node updates an F1 interface TNL association as soon as possible after the handover is completed, to restore, as soon as possible, a capability of providing a service for the terminal device, and reduce the impact on the service latency of the terminal device.

Step 505: The CU of the IAB donor determines the first TNL association information between the first IAB node and the CU of the IAB donor based on the first IP address.

In a possible embodiment, the CU of the IAB donor may establish the first TNL association between the first IAB node and the CU of the IAB donor by using the first IP address, and generate the first TNL association information. From the perspective of the CU of the IAB donor, a local endpoint of the first TNL association is the CU of the IAB donor, and a peer endpoint is the first IAB node. The first TNL association information includes an IP address set corresponding to an endpoint of the first TNL association, and the IP address set includes the first IP address.

In another possible embodiment, if the second TNL association has been established between the CU of the IAB donor and the first IAB node before the handover, and the CU of the IAB donor maintains the second TNL association information, the CU of the IAB donor updates the second TNL association information by using the first IP address, that is, adds the first IP address to an IP address set corresponding to a peer endpoint of a TNL association in the second TNL association information, to generate the first TNL association information. For example, the first IAB node may send an address configuration change (address configuration change, ASCONF) data chunk (Chunk) to the CU of the IAB donor, where the data chunk carries the first IP address that needs to be added. Optionally, the data chunk may further carry indication information (for example, the indication information is an IP address set that is of the first IAB node and that corresponds to the first TNL association) for identifying the first TNL association. After the CU of the IAB donor receives the ASCONF, the CU of the IAB donor adds the first IP address to an IP address set that corresponds to a peer endpoint of a TNL association in the first TNL association and that is maintained by the CU of the IAB donor, and then may return an address configuration acknowledgment (address configuration acknowledgment, ASCONF-ACK) data chunk (Chunk) to the first IAB node, to return a processing status (for example, a configuration success or a configuration error) of an ASCONF parameter to the first IAB node. Then, the CU of the IAB donor may send a data chunk related to the first TNL association to the first IAB node by using the first IP address.

In step 503 and step 504, a four-step handshake procedure may be used to establish the first TNL association between the first IAB node and the CU of the IAB donor, which is briefly described as follows:

Step 1: The first IAB node sends an initiation (initiation, INIT) data chunk to the CU of the IAB donor to initiate SCTP association establishment. The initiation data chunk includes mandatory parameters such as an initiate tag allocated by the first IAB node to the association, a receiving window capacity reserved for the association, a quantity of recommended output streams, a quantity of input streams, and an initial transmission sequence number (transmission sequence number, TSN) for sending data on the association; and includes optional parameters such as an IP address parameter, a cookie (COOKIE) expiration prevention parameter, a host name address parameter, and a supported address type parameter. After sending the INIT, the first IAB node starts an INIT timer and enters a cookie-wait (WAIT) state.

Step 2: After receiving the INIT data chunk sent by the first IAB node, the CU of the IAB donor sends an initiation acknowledgment (initiation acknowledgment, INIT-ACK) data chunk to the first IAB node, where the initiation acknowledgment data chunk includes state (State) cookie (Cookie). A state cookie parameter includes a message authentication code (message authentication code, MAC), a timestamp generated by the cookie, a lifetime of the cookie, and information necessary for establishing the association. The MAC is obtained through calculation based on the necessary information and a key of a CU end of the IAB donor.

Step 3: After receiving the INIT-ACK data block, the first IAB node first stops the INIT timer and leaves the cookie-wait state, and then sends, to the CU of the IAB donor, a cookie echo COOKIE ECHO data chunk, where the state cookie parameter in the received INIT-ACK data chunk is returned.

Step 4: The CU of the IAB donor sends a cookie acknowledgment (cookie acknowledgment, COOKIE-ACK) data chunk to the first IAB node, to notify the first IAB node that a TNL association (which may be specifically, for example, the first TNL association) is successfully established.

Optionally, this embodiment of this application further includes the following step 505.

Step 506: The first IAB node updates control plane context information of an F1 interface by using the first TNL association information, where the F1 interface is an interface between the first IAB node and the CU of the IAB donor.

In a possible embodiment, the first IAB node and the CU of the IAB donor transmit a control plane message of the F1 interface by using the second TNL association between the two nodes. Therefore, the control plane context information of the F1 interface maintained by the first IAB node includes the second TNL association information, and the first IAB node may generate the first TNL association information after updating the second TNL association by using the first IP address, and replace the second TNL association information in the control plane context information of the F1 interface with the first TNL association information. When the first IAB node generates the first TNL association information after updating the second TNL association by using the first IP address, the first IAB node may add the first IP address to the IP address set of the local endpoint in the second TNL association information, and further delete another existing IP address from the IP address set.

In another possible embodiment, the first IAB node and the CU of the IAB donor transmit a control plane message of the F1 interface by using the second TNL association between the two nodes. Therefore, the control plane context information of the F1 interface maintained by the first IAB node includes the second TNL association information. After establishing a new first TNL association with the CU of the IAB donor by using the first IP address, the first IAB node may add first TNL association information to the control plane context information of the F1 interface maintained by the first IAB node, that is, the first IAB node uses the first TNL association as one of TNL associations for carrying the control plane message of the F1 interface between the first IAB node and the CU of the IAB donor.

Step 507: The CU of the IAB donor updates the control plane context information of the F1 interface by using the first TNL association information.

In a possible embodiment, the first IAB node and the CU of the IAB donor transmit a control plane message of the F1 interface by using the second TNL association between the two nodes. Therefore, the control plane context information of the F1 interface maintained by the CU of the IAB donor includes the second TNL association information, and the CU of the IAB donor may generate the first TNL association information after updating the second TNL association by using the first IP address, and replace the second TNL association information in the control plane context information of the F1 interface with the first TNL association information. When the CU of the IAB donor generates the first TNL association information after updating the second TNL association by using the first IP address, the CU of the IAB donor may add the first IP address to the IP address set of the peer endpoint in the second TNL association information, and further delete another existing IP address from the IP address set.

In another possible embodiment, the first IAB node and the CU of the IAB donor transmit a control plane message of the F1 interface by using the second TNL association between the two nodes. Therefore, the control plane context information of the F1 interface maintained by the CU of the IAB donor includes the second TNL association information. After establishing a new first TNL association with the first IAB node by using the first IP address, the CU of the IAB donor may add first TNL association information to the control plane context information of the F1 interface maintained by the CU of the IAB donor, that is, the CU of the IAB donor uses the first TNL association as one of TNL associations for carrying the control plane message of the F1 interface between the first IAB node and the CU of the IAB donor.

In this embodiment of this application, the TNL association information in the control plane context information of the F1 interface is information (including a source IP address and/or a target IP address used by the TNL association) related to the TNL association for carrying the control plane message of the F1 interface. For example, the first TNL association information includes the first IP address of the first IAB node.

It should be noted that, in another possible embodiment, step 501 to step 506 shown in FIG. 5 may all be performed, or some steps may be performed. In addition, there is not necessarily a strict execution sequence of step 501 to step 506. For example, step 506 may be performed before step 505, or step 505 and step 506 may be performed in parallel. This is not specifically limited in this embodiment of this application.

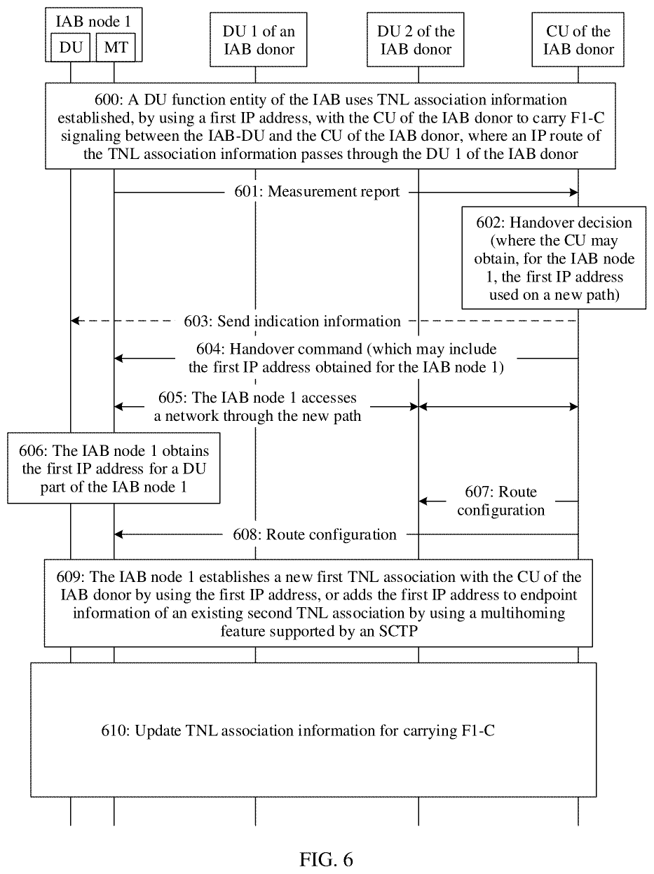

In FIG. 6, in this embodiment of this application, the foregoing communication method is further described by using an example in which a first IAB node is an IAB node 1 that is directly connected to a first DU of an IAB donor (namely, a DU 1 of an IAB donor in FIG. 6), namely, an example in which the first IAB node is the IAB node 1 in FIG. 4A.

Step 600: A DU function entity of the IAB node 1 uses one or more IP addresses to establish second TNL association information with a CU of the IAB donor, where an F1 application layer protocol (F1 application protocol, F1AP) message between the IAB node 1 and the CU of the IAB donor is carried in the second TNL association information. In step 601, the one or more IP addresses are IP addresses that are related to the DU 1 of the IAB donor and that are obtained by the IAB node 1 after the IAB node 1 is connected to the DU 1 of the IAB donor.

Step 601: The IAB node 1 sends a measurement report to the CU of the IAB donor.

Step 602: The CU of the IAB donor makes, based on the measurement report, a handover decision, that is, the IAB node 1 is to be handed over to a DU 2 of the IAB donor.

Optionally, in step 602, the CU of the IAB donor may obtain, for the IAB node 1,a new IP address (namely, the first IP address in FIG. 5) used on a path after the handover. Specifically, the CU of the IAB donor may obtain one or more new IP addresses. For a quantity of IP addresses that need to be obtained, refer to a quantity of IP addresses configured for the IAB node 1. The CU of the IAB donor may obtain the IP address from an IP address pool (pool) maintained by the CU of the IAB donor, or obtain the IP address from the DU 2 of the IAB donor, or request the IP address from a DHCP server, or obtain the IP address from an OAM.

Optionally, the method may further include step 603: The CU of the IAB donor sends indication information to the IAB node 1.

The indication information may be carried in an update message (which may be specifically the F1AP message, for example, a gNB-CU CONFIGURATION UPDATE (gNB-CU configuration update) message). The update message includes at least one of the following items: (1) to-be-removed TNL association information, (2) to-be-added TNL association information, and (3) to-be-updated TNL association information. Each of the three types of association information may include one or more items. The first IAB node may determine, based on the indication information, first transport network layer association information after the first IAB node is handed over to the second DU of the IAB donor.

(1) Transport network layer address information (which includes transport network layer address information of the CU of IAB donor, and optionally, may further include transport network layer address information of a DU part of the IAB node 1) included in each item of the to-be-removed TNL association information is transport network layer address information used by a currently established TNL association between the IAB node 1 and the CU of the IAB donor.

It should be noted that if the to-be-removed TNL association information is included, the IAB node 1 needs to perform a corresponding removal operation before step 605.

(2) The to-be-added TNL association information is TNL association information established by the IAB node 1 through a new path after the handover is completed, and transport network layer address information (which includes the transport network layer address information of the IAB donor CU, and may further include transport network layer address information allocated by the IAB donor CU to the DU part of the IAB node 1) included in each item of the association information is transport network layer address information to be used on the new path. In this application, transport network layer address information of a node may be an IP address of the node, or an IP address and a transport layer port number of the node.

(3) The to-be-updated TNL association information includes one or more items in a list of to-be-updated TNL associations. Each item includes the transport network layer address information of the CU of the IAB donor and a purpose indication of the TNL association, and is used to overwrite (or replace) corresponding information of an existing TNL association between the IAB node 1 and the CU of the IAB donor.

It should be noted that step 603 may alternatively be performed after step 604.

Step 604: The CU of the IAB donor sends a first message to the IAB node 1, where the first message is, for example, an RRC reconfiguration message, and includes a handover command. The handover command may be specifically, for example, a reconfiguration with sync (Reconfiguration with Sync) information element (Information element, IE) in an RRC message, or a mobility control information (Mobility Control Information) information element, and the handover command includes an indication indicating the IAB node 1 to be handed over to be connected to a cell served by the DU 2 of the IAB donor.

Step 605: The IAB node 1 performs handover, and initiates an access request to a new parent node, namely, the DU 2 of the IAB node donor, to complete access on the new path.

Optionally, the method further includes step 606: The IAB node 1 obtains the first IP address.

In a possible embodiment, step 606 may be performed together with step 604, and the IAB node 1 may obtain the first IP address from the CU of the IAB donor (for example, the first message carries the first IP address of the IAB node 1). In another possible embodiment, the IAB node 1 may obtain the first IP address from an OAM, or may obtain the first IP address by executing a dynamic host protocol (DHCP).

Optionally, before performing the step, the IAB node 1 may further obtain an IP address of the CU of the IAB donor from the CU of the IAB donor.

Step 607: The CU of the IAB donor sends a message to perform route configuration on

an intermediate node that the IAB node passes through on the new path, where the intermediate node includes the DU 2 of the IAB donor.

In a possible embodiment, if the IAB node 1 is connected to the IAB donor through a multi-hop backhaul network, in this step, the route configuration further needs to be performed on an intermediate IAB node on a transmission path between the IAB node 1 and the DU 2 of the IAB donor. Content of the route configuration performed on the intermediate node includes one or more downlink routing entries related to the IAB node 1, and may further include one or more uplink routing entries related to the IAB node 1. The downlink routing entry related to the IAB node 1 includes routing information of the IAB node 1 and a corresponding next-hop node. The routing information of the IAB node 1 may be an adaptation layer routing identifier (BAP routing ID), which includes a BAP layer identifier (BAP address) and a BAP layer path identifier (BAP path ID) of the IAB node 1, where the path identifier is optional and indicates a transmission path between the IAB donor and the IAB node 1. The uplink routing entry related to the IAB node 1 includes routing information of the IAB donor and a corresponding next-hop node. The routing information of the IAB donor may be an adaptation layer routing identifier, which includes a BAP layer identifier and a BAP layer path identifier of the IAB donor, where the path identifier is optional and indicates a transmission path between the IAB node 1 and the IAB donor. When the IAB donor in this step has a CU-DU split structure, the IAB donor may be specifically understood as a DU of the IAB donor or a CU of the IAB donor. For the parent node of the IAB node 1 on the new path, the content of the route configuration may further include an adaptation layer identifier (BAP address) of the IAB node 1.

Step 608: The CU of the IAB donor sends a message to perform route configuration on the IAB node 1. Content includes the one or more uplink routing entries related to the IAB node 1. For specific descriptions of the uplink routing entry, refer to the descriptions in step 607 for understanding.

Step 609: The IAB node 1 establishes a new first TNL association with the CU of the IAB donor (which may be specifically a CU-CP of the IAB donor) by using the first IP address, and generates first TNL association information, where the established first TNL association is established based on the IP address and/or transport layer port number information in the newly established or updated list provided by the CU in step 603. Alternatively, based on a multihoming feature supported by an SCTP protocol, the IAB node 1 and/or the CU of the IAB donor add/adds the first IP address to endpoint information corresponding to an existing second TNL association, and use/uses the first IP address as a first IP address that can be used to transmit a data chunk related to the second TNL association.

Step 610: Each of the IAB node 1 and the CU of the IAB donor updates TNL association information for carrying F1-C.

This step may be implemented in two manners.

Manner 1: The IAB node 1 sends a GNB-CU CONFIGURATION UPDATE ACKNOWLEDGE (CU configuration update success) message to the CU of the IAB donor, where the message carries a transport network layer address of the CU of the IAB donor corresponding to the new first TNL association that is established successfully.

Manner 2: The IAB node 1 sends a GNB-DU CONFIGURATION UPDATE (DU configuration update) message to the CU of the IAB donor, where the message carries a gNB DU ID of the IAB node 1 and the to-be-deleted second TNL association information. The newly established first TNL association is used when the message is transmitted. In this way, after receiving the message, the CU of the IAB donor may delete the corresponding second TNL association information between the CU of the IAB donor and the DU of the IAB node, and transmit the F1AP message between the CU of the IAB donor and the DU of the IAB node by using the newly established first TNL association.

It should be noted that Manner 1 is applicable when step 603 is performed. If Manner 2 is used, the CU of the IAB donor further returns a response message to the IAB node, where the response message may be a GNB-DU CONFIGURATION UPDATE ACKNOWLEDGE (DU configuration update success message) or a GNB-DU CONFIGURATION UPDATE FAILURE (DU configuration update failure). FIG. 6 does not show the step in which the CU of the IAB donor sends the response message to the IAB node 1.

In the two manners, the TNL association information carrying the F1-C signaling between the CU of the IAB donor and the IAB node can be updated without reestablishing an F1 connection in a mobile scenario in which the IAB node does not change the IAB donor.

It should be noted that step 610 is an optional step. If in step 609, the IAB node 1 uses the multihoming feature supported by the SCTP protocol to add the first IP address to information corresponding to an existing first TNL association as the first IP address that can be used to transmit a data chunk related to the first TNL association, step 610 may not be performed.

In addition, it should be noted that, in a topology update process, an IAB node whose parent node changes further includes a child node (another IAB node connected to the IAB node 1) or a secondary child node (a child node of a child node, a grandchild node of a child node, or the like), and control plane contexts of these child nodes or secondary child nodes also need to be updated. For example, when the first IAB node is the IAB node 2 in FIG. 4A or the IAB node 3 in FIG. 4B, step 603 and step 606 to step 610 may be performed to update a TNL association between the first IAB node and the CU of the IAB donor.

In this embodiment of this application, when a parent node of a first IAB node is changed due to IAB topology update, the first IAB node obtains a first IP address, and updates a control plane context between an IAB node and an IAB donor based on the first IP address, to avoid a service latency and signaling overheads caused by F1 interface reestablishment. After the handover is completed, the IAB node performs F1 interface communication with the CU of the IAB donor by obtaining the first IP address. In this way, the IAB node may communicate with the

CU of the IAB donor by using the first IP address as soon as possible after the handover is completed, thereby reducing impact on a service latency of a terminal device served by the IAB node.

### Embodiment 2

Scenario 2: In this embodiment of this application, when an IAB donor is in a form in which a DU and a CU are not split, a first IAB node is handed over from a first IAB donor to a second IAB donor, that is, the first IAB node is connected to different IAB donors before and after the handover; or when an IAB donor is in a form in which a DU and a CU are split, a first IAB donor includes a CU and a DU, and a second IAB donor includes a CU and a DU. A first IAB node is handed over from the DU of the first IAB donor to the DU of the second IAB donor, that is, the first IAB node is connected to different IAB donors before and after the handover. The first IAB node may be an IAB node directly connected to the first IAB donor or the second IAB donor, or may be connected to the first IAB donor or the second IAB donor through at least one intermediate IAB node.

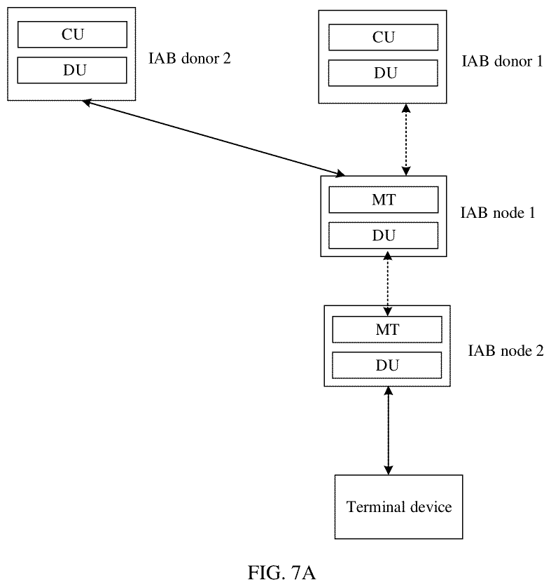

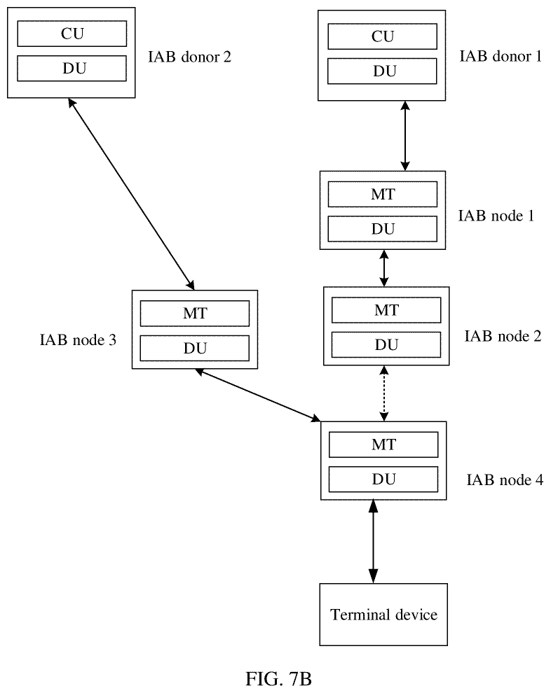

For example, as shown in FIG. 7A, an IAB node 1 is directly connected to an IAB donor 1 before handover, and the IAB node 1 is directly connected to an IAB donor 2 after the handover. The first IAB node in the scenario 2 may be the IAB node 1 in FIG. 7A.

For another example, an IAB node 2 is connected to the IAB donor 1 over wireless backhaul links having two hops (through the IAB node 1) before the IAB node 1 is handed over, and the IAB node 2 is connected to the IAB donor 2 over wireless backhaul links having two hops (through the IAB node 1) after the IAB node 1 is handed over. The first IAB node in the scenario 2 may be the IAB node 2 in FIG. 7A.

For another example, as shown in FIG. 7B, an IAB node 4 is connected to a DU of an IAB donor 1 over wireless backhaul links having three hops (through an IAB node 1 and an IAB node 2) before handover, and the IAB node 4 is connected to a DU of an IAB donor 2 over wireless backhaul links having two hops (through an IAB node 3) after the handover. The first IAB node in the scenario 2 may be the IAB node 4 in FIG. 7B.

With reference to the foregoing descriptions, FIG. 8 is a schematic flowchart of a second communication method according to an embodiment of this application. Refer to FIG. 8. The method includes the following steps.

Step 801: A CU of a first IAB donor sends a first message to a CU of a second IAB donor, where the first message includes an identifier of a first IAB node, and the first message is for requesting a first address.

The first IAB node is connected to the CU of the first IAB donor before handover, and the first IAB node is connected to the CU of the second IAB donor after the handover. In other words, the first IAB donor is a CU of a source IAB donor of the first IAB node, and the second IAB donor is a CU of a target IAB donor of the first IAB node.

It should be noted that, when the DU and the CU of the IAB donor are not split, step 801 may be replaced with the following: A first IAB donor sends a first message to a second IAB donor, where the first message includes an identifier of a first IAB node, and the first message is for requesting a first address. The first IAB node is connected to the first IAB donor before handover, and the first IAB node is connected to the second IAB donor after the handover.

In a possible implementation, the first message may be a handover request (HANDOVER REQUEST) message. Optionally, the handover request message includes a user plane context and/or a control plane connection context that are/is maintained by the CU of the first IAB donor and that are/is of an F1 interface between the CU of the first IAB donor and the first IAB node, and the identifier of the first IAB node (for example, a gNB DU ID configured by a DU part of the first IAB node). Optionally, control plane context information of the F1 interface further includes TNL association information that carries a control plane message of the F1 interface.

Step 802: The CU of the second IAB donor sends a second message to the CU of the first IAB donor. The second message includes a first IP address allocated to the first IAB node.

It should be noted that, when the DU and the CU of the IAB donor are not split, step 802 may be replaced with the following: The second IAB donor sends a second message to the first IAB donor.

In a possible embodiment, the second message may be a handover request acknowledgment (HANDOVER REQUEST ACKNOWLEDGE) message, and the handover request acknowledgment message may include the first IP address allocated by the CU of the second IAB donor to the first IAB node. Optionally, the second message may further include transport network layer address information of the CU of the second IAB donor (which may alternatively be specifically a CU-CP of the second IAB donor), which is used by the first IAB node to establish a TNL association with the CU of the second IAB donor.

In a possible embodiment, the first IP address may be obtained by the CU of the second IAB donor from an IP address pool of the CU of the second IAB donor, or is obtained by the CU of the second IAB donor from a DU of the second IAB donor, or is obtained by the CU of the second IAB donor from an operation, administration, and maintenance OAM entity, or is obtained by the CU of the second IAB donor from a DHCP server.

Step 803: The CU of the first IAB donor sends a third message to the first IAB node.

In a possible case, when the DU and the CU of the IAB donor are not split, step 803 may be replaced with the following: The first IAB donor sends a third message to the first IAB node.

In a possible case, if a control plane and a user plane of the CU of the first IAB donor are split, the CU of the first IAB donor in step 803 may be specifically replaced with the CU-CP of the first IAB donor for understanding.

The third message indicates the first IAB node to be handed over to be connected to a cell served by a second parent node. In a possible case, when the DU and the CU of the IAB donor are not split, a first parent node is the first IAB donor, or a first parent node is a second IAB node connected to the first IAB donor. The second parent node is the second IAB donor, or the second parent node is a third IAB node connected to the second IAB donor.

In a possible case, when the DU and the CU of the IAB donor are split, a parent node currently connected to the first IAB node is a first parent node. The first parent node is a DU of the first IAB donor, or the first parent node is a second IAB node connected to the CU of the first IAB donor through a DU of the first IAB donor. The second parent node is a DU of the second IAB donor, or the second parent node is a third IAB node connected to the CU of the second IAB donor through a DU of the second IAB donor.

For example, the first IAB node is the IAB node 1 in FIG. 7A, the first parent node is the DU of the IAB donor 1 to which the IAB node 1 is connected in FIG. 7A, and the second parent node may be the DU of the IAB donor 2 to which the IAB node 1 is connected in FIG. 7A.

For another example, the first IAB node is the IAB node 2 in FIG. 7A, the first parent node is the IAB node 1 to which the IAB node 2 is connected in FIG. 7A, and the second parent node is also the IAB node 1 to which the IAB node 2 is connected in FIG. 7A. That is, the first parent node and the second parent node may be the same. However, after the IAB node 1 is handed over from the DU of the IAB donor 1 to be connected to the DU of the IAB donor 2, a cell served by the IAB node 1 may change. Therefore, although the parent node connected to the IAB node 2 does not change before and after the handover, the IAB node 2 is actually connected to a different serving cell after the handover.

For another example, the first IAB node is the IAB node 4 in FIG. 7B, and the first parent node is the IAB node 2 to which the IAB node 4 is connected in FIG. 7B. The second parent node is the IAB node 3 to which the IAB node 4 is connected in FIG. 4B.

In a possible implementation, the third message may be a higher layer radio resource control (radio resource control, RRC) reconfiguration message. The RRC reconfiguration message includes a handover command, and the handover command may be an information element that specifically requires the first IAB node to perform reconfiguration with sync (reconfiguration with sync). Alternatively, the third message may be carried in another RRC message.

In a possible implementation, the third message may include the first internet protocol (internet protocol, IP) address allocated to the first IAB node. The first IP address may include at least one IP address, where each of the at least one IP address may be specifically an (internet protocol version 4, IPv4) address, or an (internet protocol version 6, IPv6) address, or a network prefix part of an IPv6 address. The first IP address is used by the first IAB node to communicate with the CU of the second IAB donor after the first IAB node is handed over to the DU of the second IAB donor.

In a possible implementation, the first message may further include an IP address of the CU of the second IAB donor, and the IP address is used by the IAB node to perform control plane communication with the CU of the second IAB donor, and/or the IP address of the CU of the second IAB donor is used by the IAB node to determine first TNL association information between the first IAB node and the CU of the second IAB donor.

Step 804: The first IAB node receives the third message, obtains the first IP address from the third message, and determines a first TNL association between the first IAB node and the CU of the second IAB donor.

In a possible implementation, the third message may further include a transport network layer address (for example, the IP address of the CU of the second IAB donor) of the CU of the second IAB donor, and the IP address is used by the first IAB node to perform control plane communication with the CU of the second IAB donor, and/or the IP address of the CU of the second IAB donor is used by the IAB node to determine first TNL association information between the first IAB node and the CU of the second IAB donor.

Optionally, before performing step 804, the first IAB node may further receive indication information from the CU of the first IAB donor, or the third message may include indication information, where the indication information indicates that an occasion for the first IAB node to determine the first TNL association information is after the first IAB node is handed over to be connected to the DU of the second IAB donor.

Step 805: The first IAB node performs handover based on the third message, to be handed over from the DU of the first IAB donor to be connected to the DU of the second IAB donor.

Specifically, the first IAB node may initiate random access in the cell served by the second parent node. After receiving a response message from the second parent node, the first IAB node may continue to perform a subsequent access step to complete access to the cell served by the second parent node.

Step 806: The first IAB node determines the first TNL association information between the first IAB node and the CU of the second IAB donor based on the first IP address and/or the IP address of the CU of the second IAB donor.

In a possible implementation, the first IAB node may initiate a first TNL association establishment process to the CU of the second IAB donor by using the first IP address and the IP address of the CU of the second IAB donor, to establish the first TNL association between the first IAB node and the CU of the second IAB donor, and generate the corresponding first TNL association information.

Step 807: The first IAB node updates control plane context information of an F1 interface by using the first TNL association information, where the F1 interface is an interface between the first IAB node and the CU of the second IAB donor.

In a possible embodiment, the first IAB node may delete an existing IP address corresponding to the first TNL association in the control plane context information of the F1 interface, and then add the first IP address to an IP address set corresponding to the first TNL association, to generate the first TNL association information.

In another possible embodiment, the first IAB node may add the newly established first TNL association information to the control plane context information of the F1 interface. The first TNL association information includes the first TNL association and the first IP address, that is, the first IAB node uses the first TNL association as one of TNL associations for carrying a control plane message of the F1 interface between the first IAB node and the CU of the IAB donor.

Optionally, step 807 further includes the following: The first IAB node uses the first TNL association to carry an F1AP message to be sent to the CU of the second IAB donor, where the F1AP message carries the identifier of the first IAB node (for example, the gNB DU ID of the DU part of the first IAB node). The F1AP message may be specifically, for example, a gNB-DU CONFIGURATION UPDATE (DU configuration update) message or an F1 SETUP REQUEST (F1 interface setup request) message.

Step 808: The CU of the second IAB donor updates the control plane context information of the F1 interface by using the first TNL association information, where the F1 interface is the interface between the first IAB node and the CU of the second IAB donor.

In a possible embodiment, the CU of the second IAB donor finds, based on the identifier of the first IAB node that is carried in the F1AP message sent by the first IAB node, from the control plane context information of the F1 interface obtained in step 801, control plane context information of an F1 interface corresponding to the identifier of the first IAB node, and then the CU of the second IAB donor may delete existing TNL association information of the control plane context information, and add the first TNL association information.

In another possible embodiment, the CU of the second IAB donor finds, based on the identifier of the first IAB node that is carried in the first message sent by the CU of the first IAB donor, from the control plane context information of the F1 interface obtained in step 801, control plane context information of an F1 interface corresponding to the identifier of the first IAB node. The CU of the second IAB donor may add the first TNL association information to the control plane context information of the F1 interface, where the first TNL association information is for describing the first TNL association, that is, the CU of the second IAB donor uses the first TNL association as one of the TNL associations for carrying the control plane message of the F1 interface between the first IAB node and the CU of the IAB donor.

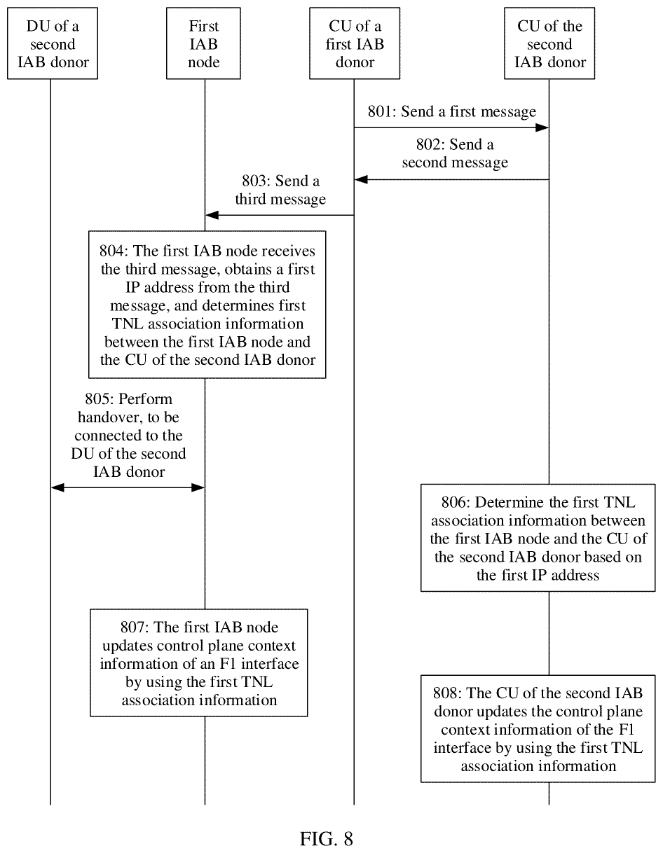

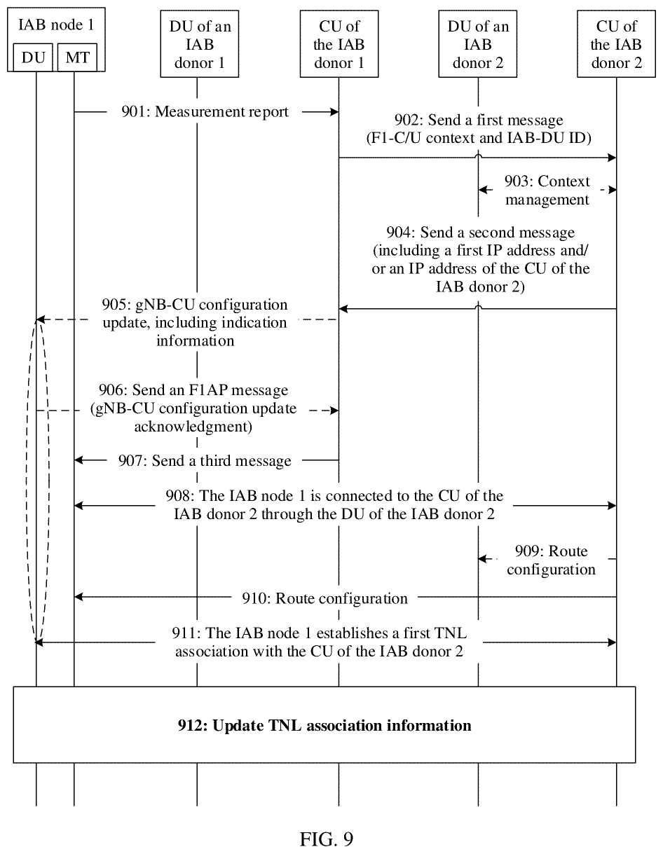

In FIG. 9, an example in which the IAB node 1 in FIG. 7A is handed over from the IAB donor 1 to the IAB donor 2 is further used for description in this embodiment of this application. The following steps are specifically included.

Step 901: The IAB node 1 sends a measurement report to a currently connected CU of the IAB donor 1.

Step 902: The CU of the IAB donor 1 determines to hand over the IAB node 1 to a cell served by the IAB donor 2, and the CU of the IAB donor 1 sends a first message, for example, a handover request (HANDOVER REQUEST) message, to a CU of the IAB donor 2.

The handover request message includes a user plane context and a control plane connection context that are maintained by the CU of the IAB donor 1 and that are of an F1 interface between the CU of the IAB donor 1 and the IAB node 1, and an identifier of the IAB node 1 (for example, a gNB DU ID configured by a DU of the IAB node 1).

In a possible embodiment, control plane context information of the F1 interface further includes context information related to TNL association information that carries a control plane of the F1 interface. The context related to the TNL association information may include transport network layer address information corresponding to the TNL association information. For one piece of transport network layer address information or a transport network layer address information pair, the context related to the TNL association information may further include a purpose of the TNL association information, where the purpose of the TNL association information mainly means that the TNL association information is for carrying UE-related F1AP signaling or carrying non-UE-related F1AP signaling. If the TNL association information is for carrying the UE-related F1AP signaling, the context may further include an identifier of UE (where the UE may be UE accessing a cell served by the IAB node 1, or a child node of the IAB node 1). The piece of transport network layer address information or the transport network layer address information pair includes transport network layer address information of the CU of the first IAB donor, and/or transport network layer address information of the first IAB node.

Optionally, this embodiment of this application further includes step 903.

Step 903: If the IAB node 1 is connected to the CU of the IAB donor 2 through a second parent node (namely, a DU of the IAB donor 2 in FIG. 7A) after handover, the CU of the IAB donor 2 may further send, to the second parent node after the IAB node 1 is handed over, an F1AP message (which may be specifically a UE CONTEXT SETUP REQUEST) for establishing, by the IAB node 1, context information at a target parent node (the second parent node). Then, the second parent node (the DU of the IAB donor 2) sends context setup response information (which may be specifically a UE CONTEXT SETUP RESPONSE) to the CU of the IAB donor 2.

Step 904: The CU of the IAB donor 2 sends a second message to the CU of the IAB donor 1, where the second message may be, for example, a handover request acknowledgment (HANDOVER REQUEST ACKNOWLEDGE) message, and may include a first IP address allocated by the CU of the IAB donor 2 to the IAB node 1.

Optionally, the handover request acknowledgment message may further include transport network layer address information of the CU of the IAB donor 2 (which may alternatively be specifically a CU-CP of the IAB donor 2), which is used by the IAB node 1 to establish TNL association information with the CU of the IAB donor 2.

Optionally, the second message may further include other configuration information to be sent to the IAB node 1, including any one or more of the following items: an adaptation layer identifier (BAP address) allocated by the CU of the IAB donor 2 to the IAB node 1, one or more uplink BAP routing identifiers (BAP routing IDs) that are available to the IAB node 1 in a network served by the CU of the IAB donor 2, an identifier of a next-hop node (namely, the second parent node after the IAB node 1 is handed over to the CU of the IAB donor 2) corresponding to each uplink BAP routing identifier, a default BH RLC channel identifier (BH RLC channel ID) for transmitting an uplink service on a link between the IAB node 1 and the second parent node, and a mapping relationship between a BH RLC channel between the IAB node 1 and the second parent node and F1-C (a control plane of an F1 interface) signaling type or non-F1 service type of the IAB node 1.

Optionally, step 905 may be further included: The CU of the IAB donor 1 sends an F1AP message (for example, a GNB-CU CONFIGURATION UPDATE message) to the IAB node 1, where the F1AP message includes at least one of the following items: (1) to-be-removed TNL association information, (2) to-be-added TNL association information, and (3) to-be-updated TNL association information. Each of the three types of information may include one or more items.

(1) Transport network layer address information included in each item of the to-be-removed TNL association information is transport network layer address information used by a currently established TNL association between the DU of the IAB node 1 and the CU of the IAB donor 1. It should be noted that if the to-be-removed TNL association information is included, the IAB node 1 needs to perform a corresponding removal operation before step 908. The transport network layer address information included in each item of the to-be-removed TNL association information may be transport network layer address information of the CU of the IAB donor 1, and optionally, may further include transport network layer address information of a DU part of the IAB node 1.

(2) The to-be-added TNL association information is TNL association information established by the IAB node 1 through a new path after the handover is completed, and transport network layer address information (which includes the transport network layer address information of the CU of the IAB donor 2, and may further include transport network layer address information allocated by the CU of the IAB donor 2 to the DU part of the IAB node 1) included in each item of the information is transport network layer address information to be used on the new path. Optionally, the message further includes specific indication information indicating that a TNL association indicated by corresponding information needs to be added after the IAB node 1 is handed over to the second parent node. In this application, transport network layer address information of a node may be an IP address of the node, or an IP address and a transport layer port number of the node. For example, if the IAB node 1 sends an RRC reconfiguration complete message to the CU of the second IAB donor, it indicates that the first IAB node is handed over to the second parent node.

(3) The to-be-updated TNL association information includes one or more items in a list of to-be-updated TNL associations. Each item includes the transport network layer address information of the CU of IAB donor 2 and a purpose indication of the TNL association, and is used to overwrite corresponding information of an existing TNL association between the IAB node 1 and the CU of the IAB donor 1. When the CU of the IAB donor 2 is in a form in which a CP and a UP are split, a transport network layer address of the CU of the IAB donor 2 in this embodiment may be specifically a transport network layer address of the CU-CP of the IAB donor 2.

Optionally, step 906 is further included: The IAB node 1 feeds back an F1AP message to the CU of the IAB donor 1. Specifically, the F1AP message may be a GNB-CU CONFIGURATION UPDATE ACKNOWLEDGE (CU configuration update acknowledgment) message. For content of the message, refer to a current 3GPP protocol (namely, 3GPP TS 38.473). However, the message does not include TNL association information to be established by the IAB node 1 with the CU of the IAB donor 2 based on the information in step 905.

It should be noted that step 906 is an optional step. Step 906 is performed when step 905 is performed.

Step 907: The CU of the IAB donor 1 sends a third message, for example, an RRC reconfiguration message, to the IAB node 1, where the RRC reconfiguration message includes a handover command, and the handover command indicates the IAB node 1 to be handed over to a cell served by the IAB donor 2.

Optionally, the RRC reconfiguration message further includes at least one first IP address configured by the CU of the IAB donor 2 for the IAB node 1. Each of the at least one first IP address is an address related to the DU of the IAB donor 2 to which the IAB node 1 is connected after the IAB node 1 performs handover. Optionally, the RRC reconfiguration message may further include an IP address of the CU of the IAB donor 2. The IP address may be used by the IAB node 1 to perform control plane communication with the CU of the IAB donor 2 on the new path after the IAB node 1 performs handover.

Optionally, the third message may further include other configuration information to be sent to the IAB node 1, including any one or more of the following items: an adaptation layer identifier (BAP address) allocated by the CU of the IAB donor 2 to the IAB node 1, one or more uplink BAP routing identifiers (BAP routing IDs) that are available to the IAB node 1 in a network served by the CU of the IAB donor 2, an identifier of a next-hop node (namely, the second parent node after the IAB node 1 is handed over to the CU of the IAB donor 2) corresponding to each uplink BAP routing identifier, a default BH RLC channel identifier (BH RLC channel ID) for transmitting an uplink service on a link between the IAB node 1 and the second parent node, and a mapping relationship between a BH RLC channel between the IAB node 1 and the second parent node and F1-C (a control plane of an F1 interface) signaling type or non-F1 service type of the IAB node 1.

Step 908: The IAB node 1 initiates a random access request in a cell served by the DU of the IAB donor 2, and is connected to the CU of the IAB donor 2 through the DU of the IAB donor 2 after completing access.

Optionally, this embodiment of this application further includes step 909. If the IAB node 1 is connected to the CU of the IAB donor 2 over a wireless backhaul link having at least one hop, the CU of the IAB donor 2 sends a message to perform route configuration on an intermediate node that the IAB node 1 passes through on the new path. The intermediate node may include the DU of the IAB donor 2, and may further include another IAB node on a transmission path between the IAB node 1 and the DU of the IAB donor 2. Content of the route configuration performed on the intermediate node includes one or more downlink routing entries related to the IAB node 1,and may further include one or more uplink routing entries related to the IAB node 1. The downlink routing entry related to the IAB node 1 includes routing information of the IAB node 1 and a corresponding next-hop node. The routing information of the IAB node 1 may be an adaptation layer routing identifier (BAP routing ID), which includes a BAP layer identifier (BAP address) and a BAP layer path identifier (BAP path ID) of the IAB node 1, where the path identifier is optional and indicates a transmission path between the IAB donor and the IAB node 1. The uplink routing entry related to the IAB node 1 includes routing information of the IAB donor 2 and a corresponding next-hop node. The routing information of the IAB donor 2 may be an adaptation layer routing identifier, which includes a BAP layer identifier and a BAP layer path identifier of the IAB donor 2, where the path identifier is optional and indicates a transmission path between the IAB node 1 and the IAB donor. When the IAB donor 2 in this step has a CU-DU split structure, the IAB donor 2 may be specifically understood as the DU of the IAB donor 2 or the CU of the IAB donor 2. For the second parent node of the IAB node 1 on the new path, content of the route configuration may further include an adaptation layer identifier (BAP address) of the IAB node 1.

Step 910: The CU of the IAB donor 2 sends a message to perform route configuration on the IAB node 1. Content includes the one or more uplink routing entries related to the IAB node 1. For specific descriptions of the content of each uplink routing entry, refer to the descriptions in step 909 for understanding.

Step 911: The IAB node 1 uses a newly configured first IP address to establish a first TNL association with the CU 2 of the IAB donor (which may alternatively be specifically the CU-CP of the CU 2 of the IAB donor). The established first TNL association is established based on the transport network layer address information in the to-be-added TNL association information or in the to-be-updated TNL association information provided by the CU 2 of the IAB donor in step 905. Alternatively, the first TNL association is established based on the IP address provided by the CU 2 of the IAB donor in step 907.

Step 912: The IAB node 1 and the CU of the IAB donor 2 updates the TNL association information.

Specifically, the IAB node 1 sends an uplink F1 AP message to the CU of the IAB donor 2. Specifically, the uplink F1AP message may be a GNB-DU CONFIGURATION UPDATE message or an F1 connection setup request (F1 SETUP REQUEST) message, and carries the gNB DU ID of the IAB node 1. The IAB node 1 uses the newly established first TNL association to carry the F1AP message.

In addition, after receiving the first uplink F1AP message of the IAB node 1, the CU of the IAB donor 2 may find, based on the gNB DU ID, the control plane context information of the F1 interface of the IAB node 1 that is previously received from the CU of the IAB donor 1; replace the second TNL association information that is in the context information and that is for carrying the control plane message of the F1 interface with the IAB node 1 with related information of the newly established first TNL association (including, for example, an IP address set corresponding to an endpoint of the first TNL association, which may be specifically a transport network layer address of the CU 2 of the IAB donor and/or a transport network layer address of the IAB node 1); and subsequently transmit an F1AP message between the CU of the IAB donor 2 and the IAB node 1 by using the newly established first TNL association.

In this embodiment of this application, when a parent node of a first IAB node is changed due to IAB topology update, the first IAB node obtains a first IP address, and updates a control plane context between an IAB node and a second IAB donor based on the first IP address, to avoid a service latency and signaling overheads caused by F1 interface reestablishment. After the handover is completed, the IAB node performs F1 interface communication with the CU of the second IAB donor by obtaining the first IP address. In this way, the IAB node may communicate with the CU of the second IAB donor by using the first IP address as soon as possible after the handover is completed, thereby reducing impact on the service latency of a terminal device served by the IAB node.

### Embodiment 3

Scenario 3: In this embodiment of this application, a first IAB node is handed over, in a service range of a CU of a same IAB donor, from a first DU of the IAB donor to a second DU of the IAB donor, that is, the first IAB node is connected to different DUs of the IAB donor but is connected to a same CU of the IAB donor before and after the handover. The first IAB node and the CU of the IAB donor update a user plane context of an F1 interface in a handover process.

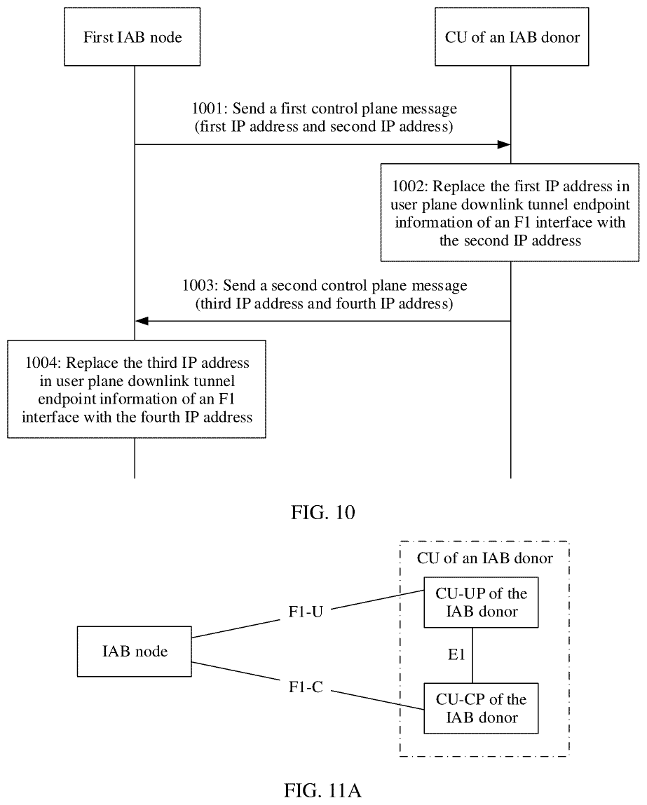

FIG. 10 is a schematic flowchart of a third communication method according to an embodiment of this application. The method is applicable to a case in which a first IAB node is handed over in an IAB donor. Specifically, the IAB donor includes a CU of the IAB donor, a first DU of the IAB donor, and a second DU of the IAB donor. The first IAB node is handed over, in a service range of the CU of the same IAB donor, from the first DU of the IAB donor to the second DU of the IAB donor, that is, the first IAB node is connected to different DUs of the IAB donor before and after the handover. Refer to FIG. 10. The method includes the following steps.

Step 1001: The first IAB node sends a first control plane message to the CU of the IAB donor, where the first control plane message includes a first IP address and a second IP address.

The first control plane message may be an F1AP message. The first IP address is an IP address of the first IAB node that is used when the first IAB node communicates with the CU of the IAB donor through a first parent node. The second IP address is an IP address of the first IAB node that is used when the first IAB node communicates with the CU of the IAB donor through a second parent node. The first parent node is the first DU of the IAB donor, or the first parent node is a second IAB node connected to the CU of the IAB donor through the first DU of the IAB donor. The second parent node is the second DU of the IAB donor, or the second parent node is a third IAB node connected to the CU of the IAB donor through the second DU of the IAB donor.

Step 1002: The CU of the IAB donor replaces, with the second IP address, the first IP address in user plane downlink tunnel endpoint information that is maintained by the CU of the IAB donor and that is of an F1 interface between the CU of the IAB donor and the first IAB node.

The CU of the IAB donor, the first DU of the IAB donor, and the second DU of the IAB donor are function entities of a same IAB donor, and the F1 interface is an interface between the first IAB node and the CU of the IAB donor.

It should be noted that step 1002 occurs after the first IAB node is handed over from the first parent node to the second parent node.

Optionally, this embodiment of this application may further include step 1003: The CU of the IAB donor sends a second control plane message to the IAB node, where the control plane message includes a third IP address and a fourth IP address.

The second control plane message may be a downlink F1AP message. The third IP address is an IP address of the CU of the IAB donor that is used when the first IAB node communicates with the CU of the IAB donor through the first parent node. The fourth IP address is an IP address of the CU of the IAB donor that is used when the first IAB node communicates with the CU of the IAB donor through the second parent node. The first parent node is the first DU of the IAB donor, or the first parent node is the second IAB node connected to the CU of the IAB donor through the first DU of the IAB donor. The second parent node is the second DU of the IAB donor, or the second parent node is the third IAB node connected to the CU of the IAB donor through the second DU of the IAB donor.

Step 1004: The first IAB node replaces, with the fourth IP address, the third IP address in user plane uplink tunnel endpoint information that is maintained by the first IAB node and that is of an F1 interface between the first IAB node and the CU of the IAB donor.

It should be noted that step 1004 is an optional step. Step 1004 is performed only after step 1003 is performed. Step 1004 occurs after the first IAB node is handed over from the first parent node to the second parent node. For a specific handover scenario and a handover manner in which the first IAB node is handed over from the first parent node to the second parent node, refer to Embodiment 1.

In addition, it should be noted that, in the foregoing method, step 1003 and step 1004 may be performed before step 1001 and step 1002.

In this embodiment of this application, when a parent node of the first IAB node is changed due to IAB topology update, the first IAB node updates a user plane context between the IAB node and the IAB donor based on the obtained third IP address and fourth IP address, to avoid a service latency and signaling overheads caused by F1 interface reestablishment.

### Embodiment 4

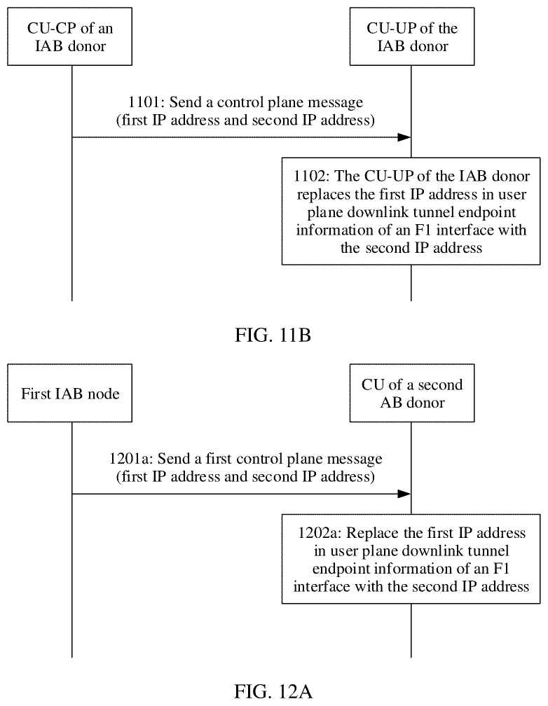

An applicable scenario is the same as the scenario 3, and the scenario is a scenario in which a control plane and a user plane of a CU of an IAB donor are split. FIG. 11A is a schematic flowchart of a fourth communication method according to an embodiment of this application. Refer to FIG. 11B. The method includes the following steps.

Step 1101: A CU-CP of an IAB donor sends a control plane message to a CU-UP of the IAB donor, where the control plane message includes a first IP address and a second IP address.

Optionally, the control plane message is an E1 interface application protocol (E1 Application, E1AP) message between the CU-CP of the IAB donor and the CU-UP of the IAB donor.

The first IP address is an IP address of a first IAB node that is used when the first IAB node communicates with the CU-UP of the IAB donor through a first parent node. The second IP address is an IP address of the first IAB node that is used when the first IAB node communicates with the CU-UP of the IAB donor through a second parent node. The first parent node is a first DU of the IAB donor, or the first parent node is a second IAB node connected to the CU-UP of the IAB donor through a first DU of the IAB donor. The second parent node is a second DU of the IAB donor, or the second parent node is a third IAB node connected to the CU-UP of the IAB donor through a second DU of the IAB donor.

Optionally, in step 1101, the control plane message sent by the CU-CP of the IAB donor to the CU-UP of the IAB donor may directly include one or more pieces of second F1-U interface tunnel information, and may further include first tunnel information corresponding to each piece of second F1-U interface tunnel information or DRB information of UE corresponding to each piece of second F1-U interface tunnel information. The first F1-U interface tunnel information is F1-U interface tunnel information transmitted between the first IAB node and the CU-UP of the IAB donor through the first parent node. The second F1-U interface tunnel information is F1-U interface tunnel information transmitted between the first IAB node and the CU-UP of the IAB donor through the second parent node. Each piece of F1-U interface tunnel information includes an IP address and a GTP tunnel endpoint identifier (tunnel endpoint identifier, TEID). The DRB information of the UE corresponding to each piece of second F1-U interface tunnel information may include an identifier of the UE and a DRB identifier of the UE.

Step 1102: The CU-UP of the IAB donor replaces the first IP address in user plane downlink tunnel endpoint information of an F1 interface with the second IP address.

In this embodiment of this application, when a parent node of the first IAB node is changed due to IAB topology update, the CU-UP of the second IAB donor updates a user plane context between the IAB node and the IAB donor based on the obtained first IP address and second IP address, to avoid a service latency and signaling overheads caused by F1 interface reestablishment.

### Embodiment 5

Scenario 5: In this embodiment of this application, a first IAB node is handed over between different IAB donors, that is, the first IAB node is connected to different IAB donors before and after the handover. The first IAB node and a CU of a second IAB donor update a user plane context of an F1 interface in a handover process.

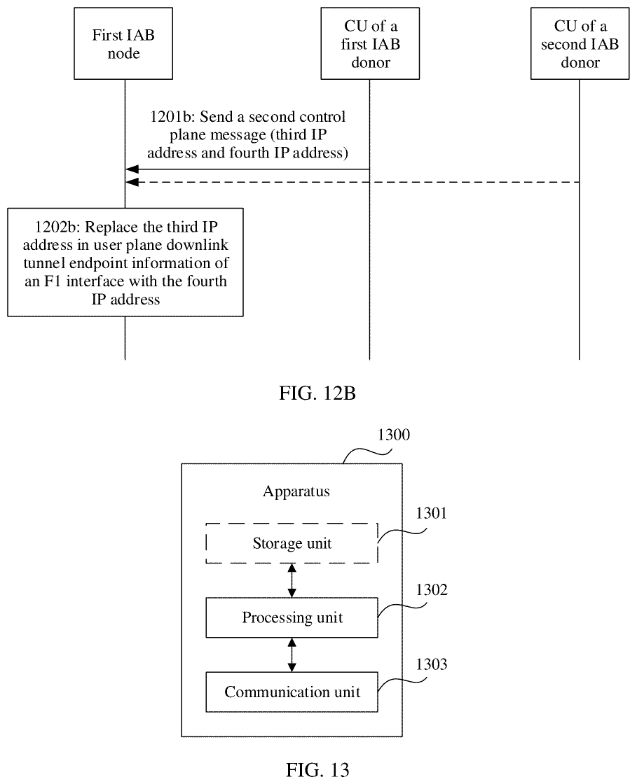

FIG. 12A is a schematic flowchart of a fifth communication method according to an embodiment of this application. The method is applicable to a case in which an IAB donor before a first IAB node performs handover is different from an IAB donor after the first IAB node performs handover. Specifically, when the IAB donor is in a form in which a DU and a CU are not split, the first IAB node is handed over from a first IAB donor to a second IAB donor, that is, the first IAB node is connected to different IAB donors before and after the handover; or when the IAB donor is in a form in which a DU and a CU are split, a first IAB donor includes a CU and a DU, and a second IAB donor includes a CU and a DU. The first IAB node is handed over from the DU of the first IAB donor to the DU of the second IAB donor, that is, the first IAB node is connected to different IAB donors before and after the handover. Refer to FIG. 12A. The method includes the following steps.

Step 1201a: The first IAB node sends a first control plane message to the CU of the second IAB donor, where the first control plane message includes a first IP address and a second IP address.

The first control plane message may be an F1AP message. The first IP address is an IP address of the first IAB node that is used when the first IAB node communicates with the CU of the first IAB donor through a first parent node. The second IP address is an IP address of the first IAB node that is used when the first IAB node communicates with the CU of the second IAB donor through a second parent node. The first parent node is the DU of the first IAB donor, or the first parent node is a second IAB node connected to the CU of the first IAB donor through the DU of the first IAB donor. The second parent node is the DU of the second IAB donor, or the second parent node is a third IAB node connected to the CU of the second IAB donor through the DU of the second IAB donor.

Step 1202a: The CU of the second IAB donor replaces, with the second IP address, the first IP address in user plane downlink tunnel endpoint information that is maintained by the CU of the second IAB donor and that is of an F1 interface between the CU of the second IAB donor and the first IAB node.

The F1 interface may be an interface between the first IAB node and the CU of the second IAB donor.

For a specific handover scenario and a handover manner in which the first IAB node is handed over from the CU of the first IAB donor to the CU of the second IAB donor, refer to Embodiment 1.

In this embodiment of this application, when a parent node of the first IAB node is changed due to IAB topology update, the CU of the second IAB donor updates a user plane context between the IAB node and the IAB donor based on the obtained first IP address and second IP address, to avoid a service latency and signaling overheads caused by F1 interface reestablishment.

FIG. 12B is a schematic flowchart of a sixth communication method according to an embodiment of this application. The method is also applicable to a case in which an IAB donor before a first IAB node performs handover is different from an IAB donor after the first IAB node performs handover. Specifically, when the IAB donor is in a form in which a DU and a CU are not split, the first IAB node is handed over from a first IAB donor to a second IAB donor, that is, the first IAB node is connected to different IAB donors before and after the handover; or when the IAB donor is in a form in which a DU and a CU are split, a first IAB donor includes a CU and a DU, and a second IAB donor includes a CU and a DU. The first IAB node is handed over from the DU of the first IAB donor to the DU of the second IAB donor, that is, the first IAB node is connected to different IAB donors before and after the handover. Refer to FIG. 12B. The method includes the following steps.

Step 1201b:The CU of the first IAB donor sends a second control plane message to the first IAB node, where the second control plane message includes a third IP address and a fourth IP address. The fourth IP address may be obtained by the CU of the first IAB donor from the CU of the second IAB donor.

To be specific, before the first IAB node is handed over to the CU of the second IAB donor, the first IAB node may obtain the third IP address and the fourth IP address from the CU of the first IAB donor.

Optionally, step 1201b may alternatively be as follows: The CU of the second IAB donor sends a second control plane to the first IAB node. To be specific, after the first IAB node is handed over to the CU of the second IAB donor, the first IAB node may obtain the third IP address and the fourth IP address from the CU of the second IAB donor.

The second control plane message may be an F1AP message. The third IP address is an IP address of the CU of the first IAB donor that is used when the first IAB node communicates with the CU of the first IAB donor through a first parent node. The fourth IP address is an IP address of the CU of the second IAB donor that is used when the first IAB node communicates with the CU of the second IAB donor through a second parent node.

Step 1202b: The first IAB node replaces, with the fourth IP address, the third IP address in user plane uplink tunnel endpoint information that is maintained by the first IAB node and that is of an F1 interface between the first IAB node and the CU of the second IAB donor.

In addition, it should be noted that, in the foregoing method, step 1203 and step 1204 may be performed before step 1201 and step 1202.

In this embodiment of this application, when a parent node of the first IAB node is changed due to IAB topology update, the first IAB node updates a user plane context between the IAB node and the IAB donor based on the obtained third IP address and fourth IP address, to avoid a service latency and signaling overheads caused by F1 interface reestablishment.

For Embodiment 1 to Embodiment 5, it should be noted that: (1) Embodiment 1 and Embodiment 5 may be separately implemented in different scenarios, or may be implemented in combination in a same scenario, or different solutions involved in different embodiments may be implemented in combination (for example, some or all solutions involved in Embodiment 1 may be implemented in combination with Embodiment 3). This is not specifically limited.

(2) Step numbers in the flowcharts described in embodiments of this application are merely an example of an execution procedure, and do not constitute any limitation on an execution sequence of the steps. In embodiments of this application, there is no strict execution sequence between steps that do not have a time sequence dependency relationship with each other.

The foregoing mainly describes the solutions provided in embodiments of this application from a perspective of interaction between a network device and a terminal device. It may be understood that, to implement the foregoing functions, the network device or the terminal device may include a corresponding hardware structure and/or a software module for performing each function. A person skilled in the art should be easily aware that, in combination with units and algorithm steps of the examples described in embodiments disclosed in this specification, embodiments of this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, division into functional units may be performed on the terminal device and the network device based on the foregoing method examples. For example, division into each functional unit may be based on each corresponding function, or two or more functions may be integrated into one unit. The integrated unit may be implemented in a form of hardware, or may be implemented in a form of a software functional unit.

When an integrated unit is used, FIG. 13 is a possible example block diagram of an apparatus according to an embodiment of this application. As shown in FIG. 13, an apparatus 1300 may include a processing unit 1302 and a communication unit 1303. The processing unit 1302 is configured to control and manage an action of the apparatus 1300. The communication unit 1303 is configured to support communication between the apparatus 1300 and another device.

Optionally, the communication unit 1303 is also referred to as a transceiver unit, and may include a receiving unit and/or a sending unit, respectively configured to perform a receiving operation and a sending operation. The apparatus 1300 may further include a storage unit 1301, configured to store program code and/or data of the apparatus 1300.

The apparatus 1300 may be the first IAB node in any one of the foregoing embodiments, or may be a chip disposed in the first IAB node. The processing unit 1302 may support the apparatus 1300 in performing actions of the first IAB node in the foregoing method examples. Alternatively, the processing unit 1302 mainly performs internal actions of the first IAB node in the method examples, and the communication unit 1303 may support communication between the apparatus 1300 and a network device (for example, a CU of an IAB donor). For example, the communication unit 1303 may be configured to perform step 502 in FIG. 5.

The apparatus 1300 may be a network device (for example, the CU of the IAB donor or the IAB donor in the foregoing embodiments) in any one of the foregoing embodiments, or may be a chip disposed in a network device. The processing unit 1302 may support the apparatus 1300 in performing actions of the network device in the foregoing method examples. Alternatively, the processing unit 1302 mainly performs internal actions of the network device in the method examples, and the communication unit 1303 may support communication between the apparatus 1300 and a first IAB node. For example, the processing unit 1302 may be configured to perform internal actions of the IAB donor in the method examples, and the communication unit 1303 may be configured to perform step 501 in FIG. 5.

It should be understood that division of the foregoing apparatus into units is merely division into logical functions. During actual implementation, all or some of the units may be integrated into one physical entity, or may be physically separated. In addition, all the units in the apparatus may be implemented in a form in which a processing element invokes software, or may be implemented in a form of hardware; or some units may be implemented in a form of software invoked by a processing element, and some units may be implemented in a form of hardware. For example, the units may be separately disposed processing elements, or may be integrated into a chip of the apparatus for implementation. In addition, the units may be stored in a memory in a program form, and is invoked by a processing element of the apparatus to perform functions of the units. In addition, all or some of the units may be integrated, or may be implemented independently.

The processing element herein may also be referred to as a processor, and may be an integrated circuit having a signal processing capability. During implementation, steps in the foregoing methods or the foregoing units may be implemented by using a hardware integrated logical circuit in the processor element, or may be implemented in the form in which a processing element invokes software.

For example, a unit in any one of the foregoing apparatuses may be one or more integrated circuits configured to implement the foregoing methods, for example, one or more application-specific integrated circuits (Application-Specific Integrated Circuits, ASICs), one or more microprocessors (digital signal processors, DSPs), one or more field programmable gate arrays (Field Programmable Gate Arrays, FPGAs), or a combination of at least two of the integrated circuits. For another example, when the unit in the apparatus is implemented by scheduling a program by a processing element, the processing element may be a processor, for example, a central processing unit (central processing unit, CPU) or another processor that can invoke the program. For another example, the units may be integrated together and implemented in a form of a system-on-a-chip (system-on-a-chip, SOC).

The foregoing receiving unit is an interface circuit of the apparatus, and is configured to receive a signal from another apparatus. For example, when the apparatus is implemented by a chip, the receiving unit is an interface circuit that is of the chip and that is configured to receive a signal from another chip or apparatus. The foregoing sending unit is an interface circuit of the apparatus, and is configured to send a signal to another apparatus. For example, when the apparatus is implemented by a chip, the sending unit is an interface circuit that is of the chip and that is configured to send a signal to another chip or apparatus.

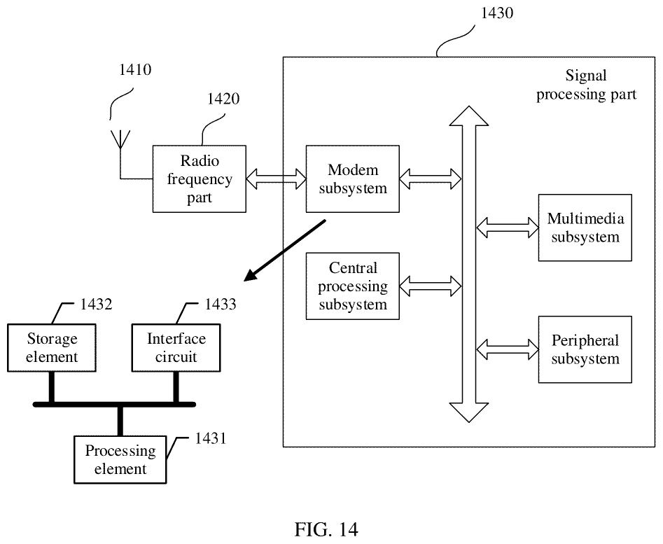

FIG. 14 is a schematic diagram of a structure of an IAB node according to an embodiment of this application. The IAB node may be the IAB node in the foregoing embodiments, and is configured to perform the operations performed by the IAB node in the foregoing embodiments. As shown in FIG. 14, the IAB node includes an antenna 1410, a radio frequency part 1420, and a signal processing part 1430. The antenna 1410 is connected to the radio frequency part 1420. In a downlink direction, the radio frequency part 1420 receives, through the antenna 1410, information sent by a network device, and sends, to the signal processing part 1430 to process, the information sent by the network device. In an uplink direction, the signal processing part 1430 processes information from the IAB node, and sends the information to the radio frequency part 1420. The radio frequency part 1420 processes the information from the IAB node, and then sends the processed information to the network device through the antenna 1410.

The signal processing part 1430 may include a modulation/demodulation subsystem, configured to implement data processing at each communication protocol layer, and may further include a central processing subsystem, configured to process an operating system and an application layer of the IAB node.

The modem subsystem may include one or more processing elements 1431, for example, include one main control CPU and another integrated circuit. In addition, the modem subsystem may further include a storage element 1432 and an interface circuit 1433. The storage element 1432 is configured to store data and a program. However, the program used to perform the methods performed by the IAB node in the foregoing methods may not be stored in the storage element 1432, but is stored in a memory outside the modem subsystem, and is loaded and used by the modem subsystem when to be used. The interface circuit 1433 is configured to communicate with another subsystem.

The modem subsystem may be implemented by a chip. The chip includes at least one processing element and an interface circuit. The processing element is configured to perform the steps of any method performed by the foregoing IAB node. The interface circuit is configured to communicate with another apparatus. In an implementation, units in the IAB node that implement the steps in the foregoing methods may be implemented in a form of scheduling a program by a processing element. For example, an apparatus used in the IAB node includes a processing element and a storage element. The processing element invokes a program stored in the storage element, to perform the methods performed by the IAB node in the foregoing method embodiments. The storage element may be a storage element located on a same chip as the processing element, namely, an on-chip storage element.

In another implementation, a program used to perform the methods performed by the IAB node in the foregoing methods may be in a storage element located on a different chip from the processing element, namely, an off-chip storage element. In this case, the processing element invokes or loads the program from the off-chip storage element to the on-chip storage element, to invoke and perform the methods performed by the IAB node in the foregoing method embodiments.

In still another implementation, units in the IAB node that implement the steps in the foregoing methods may be configured as one or more processing elements. These processing elements are disposed on the modem subsystem. The processing element herein may be an integrated circuit, for example, one or more ASICs, one or more DSPs, one or more FPGAs, or a combination of these types of integrated circuits. These integrated circuits may be integrated to form a chip.

Units in the IAB node that implement the steps in the foregoing methods may be integrated together and implemented in a form of an SOC, and the SOC chip is configured to implement the foregoing methods. At least one processing element and a storage element may be integrated into the chip, and the processing element invokes a program stored in the storage element to implement the foregoing methods performed by the IAB node. Alternatively, at least one integrated circuit may be integrated into the chip, to implement the foregoing methods performed by the IAB node. Alternatively, with reference to the foregoing implementations, functions of some units may be implemented by invoking a program by the processing element, and functions of some units may be implemented by the integrated circuit.

It can be learned that the foregoing apparatus used in the IAB node may include at least one processing element and an interface circuit. The at least one processing element is configured to perform any one of the methods performed by the IAB node provided in the foregoing method embodiments. The processing element may perform some or all steps performed by the IAB node in a first manner, that is, by invoking a program stored in the storage element; or may perform some or all steps performed by the IAB node in a second manner, that is, by combining instructions and a hardware integrated logical circuit in the processor element. Certainly, some or all steps performed by the IAB node may be alternatively performed by combining the first manner and the second manner.

The processing element herein is the same as that described above, and may be implemented by using a processor. A function of the processing element may be the same as a function of the processing unit described in FIG. 13. For example, the processing element may be a general-purpose processor, for example, a CPU, or may be one or more integrated circuits configured to implement the foregoing methods, for example, one or more ASICs, one or more microprocessors DSPs, one or more FPGAs, or a combination of at least two of these types of integrated circuits. The storage element may be implemented by using a memory. A function of the storage element may be the same as a function of the storage unit described in FIG. 13. The storage element may be implemented by using a memory. A function of the storage element may be the same as a function of the storage unit described in FIG. 13. The storage element may be one memory, or an umbrella term of a plurality of memories.

The IAB node shown in FIG. 14 may implement processes related to the IAB node in the method embodiments shown in FIG. 5, FIG. 6, and FIG. 8 to FIG. 12B. Operations and/or functions of the modules in the IAB node shown in FIG. 14 are intended to implement the corresponding procedures in the foregoing method embodiments. For details, refer to the descriptions in the foregoing method embodiments. To avoid repetition, detailed descriptions are properly omitted herein.

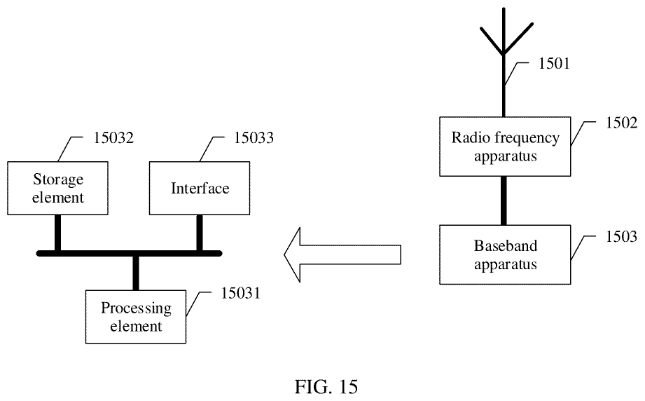

FIG. 15 is a schematic diagram of a structure of a network device according to an embodiment of this application. The network device is configured to implement the operations of the network device in the foregoing embodiments. As shown in FIG. 15, the network device includes an antenna 1501, a radio frequency apparatus 1502, and a baseband apparatus 1503. The antenna 1501 is connected to the radio frequency apparatus 1502. In an uplink direction, the radio frequency apparatus 1502 receives, through the antenna 1501, information sent by a terminal device, and sends, to the baseband apparatus 1503 to process, the information sent by the terminal device. In a downlink direction, the baseband apparatus 1503 processes information of the terminal device, and sends the information to the radio frequency apparatus 1502. The radio frequency apparatus 1502 processes the information of the terminal device, and then sends the processed information to the terminal device through the antenna 1501.

The baseband apparatus 1503 may include one or more processing elements 15031, for example, include one main control CPU and another integrated circuit. In addition, the baseband apparatus 1503 may further include a storage element 15032 and an interface 15033. The storage element 15032 is configured to store a program and data. The interface 15033 is configured to exchange information with the radio frequency apparatus 1502, and the interface is, for example, a common public radio interface (common public radio interface, CPRI). The foregoing apparatus used in the network device may be located in the baseband apparatus 1503. For example, the foregoing apparatus used in the network device may be a chip on the baseband apparatus 1503. The chip includes at least one processing element and an interface circuit. The processing element is configured to perform the steps in any one of the methods performed by the network device. The interface circuit is configured to communicate with another apparatus. In an implementation, units in the network device that implement the steps in the foregoing methods may be implemented in a form of scheduling a program by a processing element. For example, an apparatus used in the network device includes a processing element and a storage element. The processing element invokes a program stored in the storage element, to perform the method performed by the network device in the foregoing method embodiments. The storage element may be a storage element that is located on a same chip as the processing element, namely, an on-chip storage element, or may be a storage element that is located on a different chip from the processing element, namely, an off-chip storage element.

In another implementation, units in the network device that implement the steps in the foregoing methods may be configured as one or more processing elements. The processing elements are disposed on the baseband apparatus. The processing element herein may be an integrated circuit, for example, one or more ASICs, one or more DSPs, one or more FPGAs, or a combination of these types of integrated circuits. These integrated circuits may be integrated to form a chip.

Units in the network device that implement the steps in the foregoing methods may be integrated together, and implemented in a form of a system-on-a-chip (system-on-a-chip, SOC). For example, the baseband apparatus includes the SOC chip, and is configured to implement the foregoing methods. At least one processing element and a storage element may be integrated into the chip, and the processing element invokes a program stored in the storage element to implement the foregoing methods performed by the network device. Alternatively, at least one integrated circuit may be integrated into the chip, to implement the foregoing methods performed by the network device. Alternatively, with reference to the foregoing implementations, functions of some units may be implemented by invoking a program by the processing element, and functions of some units may be implemented by the integrated circuit.

It can be learned that the foregoing apparatus used in the network device may include at least one processing element and an interface circuit. The at least one processing element is configured to perform any one of the methods performed by the network device provided in the foregoing method embodiments. The processing element may perform some or all steps performed by the network device in a first manner, that is, by invoking a program stored in the storage element; or may perform some or all steps performed by the network device in a second manner, that is, by combining instructions and a hardware integrated logic circuit in the processor element. Certainly, some or all steps performed by the network device may be alternatively performed by combining the first manner and the second manner.

The processing element herein is the same as that described above, and may be implemented by using a processor. A function of the processing element may be the same as a function of the processing unit described in FIG. 10. For example, the processing element may be a general-purpose processor, for example, a CPU, or may be one or more integrated circuits configured to implement the foregoing methods, for example, one or more ASICs, one or more microprocessors DSPs, one or more FPGAs, or a combination of at least two of these types of integrated circuits. The storage element may be implemented by using a memory. A function of the storage element may be the same as a function of the storage unit described in FIG. 13. The storage element may be implemented by using a memory. A function of the storage element may be the same as a function of the storage unit described in FIG. 13. The storage element may be one memory, or an umbrella term of a plurality of memories.

The network device shown in FIG. 15 may implement processes related to the network device in the foregoing method embodiments. Operations and/or functions of the modules in the network device shown in FIG. 15 are intended to implement the corresponding procedures in the foregoing method embodiments. For details, refer to the descriptions in the foregoing method embodiments. To avoid repetition, detailed descriptions are properly omitted herein.

A person skilled in the art should understand that embodiments of this application may be provided as a method, a system, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, a CD-ROM, an optical memory, and the like) that include computer usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or the processor of the another programmable data processing device generate an apparatus for implementing a specific function in one or more processes in the flowcharts and/or in one or more blocks in the block diagrams.

These computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more processes in the flowcharts and/or in one or more blocks in the block diagrams.

It is clear that a person skilled in the art can make various modifications and variations to this application without departing from the spirit and scope of this application. This application is intended to cover these modifications and variations of this application provided that they fall within the scope of protection defined by the following claims of this application and their equivalent technologies.

What is claimed is:

1. An apparatus for a user plane functional unit of a centralized unit (CU-UP) of an integrated access and backhaul (IAB) donor, comprising:
at least one processor; and
a memory coupled to the at least one processor and storing programming instructions for execution by the at least one processor, wherein the programming instructions instruct the at least one processor to perform operations to:
receive a control plane message from a control plane functional unit of the centralized unit (CU-CP) of the IAB donor, wherein the control plane message comprises a first internet protocol (IP) address and a second IP address; the first IP address is an IP address of a first IAB node in response to the first IAB node communicating with the CU-UP of the IAB donor through a first parent node; the second IP address is an IP address of the first IAB node in response to the first IAB node communicating with the CU-UP of the IAB donor through a second parent node; and wherein
the first parent node is a first distributed unit (DU) of the IAB donor, or the first parent node is connected to the CU-UP of the IAB donor through a first distributed unit DU of the IAB donor;
and the second parent node is a second DU of the IAB donor, or the second parent node is connected to the CU-UP of the IAB donor through a second DU of the IAB donor; and
replace the first IP address in user plane downlink tunnel endpoint information of a first interface with the second IP address, wherein
the first DU of the IAB donor, the second DU of the IAB donor, the CU-CP of the IAB donor, and the CU-UP of the IAB donor are function entities of a same IAB donor, and the first interface is an interface between the first IAB node and the CU-UP of the IAB donor.

2. The apparatus according to claim 1, wherein the control plane message is an F1AP message.

3. The apparatus according to claim 1, wherein the first IAB node is handed over from the first parent node to the second parent node.

4. An apparatus for a control plane functional unit of a centralized unit (CU-CP) of an integrated access and backhaul (IAB) donor, comprising:
at least one processor; and
a memory coupled to the at least one processor and storing programming instructions for execution by the at least one processor, wherein the programming instructions instruct the at least one processor to perform operations to:
send a control plane message to a user plane functional unit of a centralized unit, CU-UP, of the IAB donor, wherein the control plane message comprises a first internet protocol IP address and a second IP address; and wherein
the first IP address is an IP address of a first IAB node in response to the first IAB node communicating with the CU-UP of the IAB donor through a first parent node; the second IP address is an IP address of the first IAB node in response to the first IAB node communicating with the CU-UP of the IAB donor through a second parent node;
the first parent node is a first DU of the IAB donor, or the first parent node is connected to the CU-UP of the IAB donor through a first distributed unit, DU, of the IAB donor; the second parent node is a second DU of the IAB donor, or the second parent node is connected to the CU-UP of the IAB donor through a second DU of the IAB donor; and
the first DU of the IAB donor, the second DU of the IAB donor, the CU-CP of the IAB donor, and the CU-UP of the IAB donor are function entities of a same IAB donor, and the first interface is an interface between the first IAB node and the CU-UP of the IAB donor.

5. The apparatus according to claim 4, wherein the control plane message is an F1AP message.

6. The apparatus according to claim 4, wherein the first IAB node is handed over from the first parent node to the second parent node.

7. A communication method, comprising:
receiving, by a user plane functional unit of a centralized unit (CU-UP) of an integrated access and backhaul (IAB) donor, a control plane message from a control plane functional unit of the centralized unit (CU-CP) of the IAB donor, wherein the control plane message comprises a first internet protocol (IP) address and a second IP address; the first IP address is an IP address of a first IAB node in response to the first IAB node communicating with the CU-UP of the IAB donor through a first parent node; the second IP address is an IP address of the first IAB node in response to the first IAB node communicating with the CU-UP of the IAB donor through a second parent node; and wherein
the first parent node is a first distributed unit (DU) of the IAB donor, or the first parent node is connected to the CU-UP of the IAB donor through a first distributed unit DU of the IAB donor; and the second parent node is a second DU of the IAB donor, or the second parent node is connected to the CU-UP of the IAB donor through a second DU of the IAB donor; and
replacing, by the CU-UP of the IAB donor, the first IP address in user plane downlink tunnel endpoint information of a first interface with the second IP address, wherein
the first DU of the IAB donor, the second DU of the IAB donor, the CU-CP of the IAB donor, and the CU-UP of the IAB donor are function entities of a same IAB donor, and the first interface is an interface between the first IAB node and the CU-UP of the IAB donor.

8. The method according to claim 7, wherein the method further comprises:
sending, by the CU-CP of the IAB donor, the the control plane message to the CU-UP of the IAB donor.

9. The method according to claim 7, wherein the control plane message is an F1AP message.

10. The method according to claim 7, wherein the first IAB node is handed over from the first parent node to the second parent node.
